(19) United States
(12) Patent Application Publication
(10) Pub. No.: US 2016/0033085 A1
(43) Pub. Date: Feb. 4, 2016

(54) COMPRESSED GAS STORAGE UNIT AND FILL METHODS

(71) Applicant: LIGHTSAIL ENERGY, INC., Berkeley, CA (US)

(72) Inventors: Neel SIROSH, Irvine, CA (US); Edwin P. BERLIN, JR., Oakland, CA (US); Eric JOHNSON, San Francisco, CA (US); Karthick CHANDRASEKER, Berkeley, CA (US); Rodrigo SUSPERREGUY, Castro Valley, CA (US); Christopher PAIS, Walnut Creek, CA (US); Danielle FONG, Berkeley, CA (US)

(21) Appl. No.: 14/812,961

(22) Filed: Jul. 29, 2015

Related U.S. Application Data
(60) Provisional application No. 62/031,758, filed on Jul. 31, 2014.
(60) Provisional application No. 62/152,760, filed on Apr. 24, 2015.
(60) Provisional application No. 62/154,647, filed on Apr. 29, 2015.

(51) Int. Cl. F17C 13/04; F17C 13/02; G05D 9/12; F17C 1/02

(52) U.S. Cl. CPC F17C 13/04; F17C 1/02; F17C 13/026; G05D 9/12; F17C 2250/0439

(57) ABSTRACT

Embodiments are directed to compressed gas storage units exhibiting one or more safety features. Particular embodiments employ a pressure relief mechanism to rapidly yet safely vent the contents of the tank in the event of a fire. The mechanism may comprise an internally piloted relief valve in communication with temperature-sensitive element(s) present along the tank dimensions. Under high temperature conditions indicative of a fire, the element communicates a signal to open the internally piloted relief valve. In some embodiments the element is configured to communicate a heat signal (e.g., by thermal conduction). In certain embodiments the element is configured to communicate a pressure change signal (e.g., pneumatic, hydraulic). In other embodiments the element may communicate different signal types, such as electric (e.g., thermoelectric) or mechanical (e.g., shear or tension forces). Also disclosed is a module incorporating a plurality of tanks to offer enhanced storage capacity.

### CROSS-REFERENCE TO RELATED APPLICATIONS

The instant nonprovisional patent application claims priority to the following provisional applications, each of which is incorporated by reference in its entirety herein for all purposes: U.S. Provisional Patent Application No. 62/031,758, filed Jul. 31, 2014; U.S. Provisional Patent Application No. 62/152,760, filed Apr. 24, 2015; and U.S. Provisional Patent Application No. 62/154,647, filed Apr. 29, 2015.

### BACKGROUND

Recently, approaches employing compressed gas as an energy storage medium, have emerged. In particular, compressed air is capable of storing energy at densities comparable to lead-acid batteries. Moreover, compressed gas does not involve issues associated with a battery such as limited lifetime, materials availability, or environmental friendliness. Accordingly it is desirable to be able to store compressed gas within a tank or other pressure vessel, in a rapid and efficient manner.

Another emerging trend in the field of energy production is the increasing availability of natural gas as a fuel source. Such natural gas may be transported in gaseous form as compressed natural gas (CNG), with economic merits of CNG being dependent upon density of the stored CNG. Again, it is desirable to be able to store CNG within a tank or other pressure vessel, in a rapid and efficient manner.

The containment of compressed natural gas and compressed air can be challenging due to concerns with corrosion and fatigue. Natural gas (especially untreated natural gas directly from well-heads) varies widely in its constituents, and may include contaminants such as hydrogen sulfide, n-hexanes, and/or water. Also, air is oxygen-rich and saturated with water.

Lower-cost approaches such as welded tubes and high strength steel tubes with polymer coatings, may experience premature failure due to phenomena such as hydrogen embrittlement, pin-holing, and gas permeation to the substrate. Other metals, for example Aluminum, may not be suitable for storage of an oxygen-rich, moist gas. Recent advances in high strength steel (HSS) may not be able to be leveraged owing to factors such as corrosion concerns, fatigue life requirements, and regulatory constraints.

High wall stresses accelerate failures due to hydrogen embrittlement in the presence of hydrogen sulfide in natural gas. Steel pressure vessels are designed with thick walls to ensure low stresses and therefore, to preserve fatigue life. However, thick walled tanks are expensive due to material costs and processing challenges ensuring uniformity of heat-treatment and inspection.

Small diameter steel tanks can be produced economically. Such small steel tanks, however, may not be practical for storing large quantities of gas due to the high cost of steel pipes and fittings. Thus, the economies of scale associated with smaller diameter industrial steel tanks may not be able to be taken advantage of for large scale gas storage.

Approaches to gas storage employing a polymer-lined composite tank, can help to decouple corrosion-resistance from the strength requirement for pressure management. Corrosion and permeation resistant polymer-lining allows the deployment of a thin high strength composite wall, which leads to an economical gas storage solution. However, the construction materials of such pressure vessels are sensitive to fire, and must be protected.

### SUMMARY

Certain embodiments are directed to compressed gas storage units exhibiting one or more safety features. Particular embodiments employ a pressure relief mechanism to rapidly yet safely vent the contents of the tank in the event of high temperature exposure or a fire. The mechanism may comprise an internally piloted relief valve in communication with temperature-sensitive element(s) present along the tank dimensions. Under high temperature conditions indicative of a fire, the element communicates a signal to open an internally piloted relief valve. In some embodiments the element is configured to communicate a heat signal (e.g., by thermal conduction). In certain embodiments the element is configured to communicate a pressure change signal (e.g., pneumatic, hydraulic). In other embodiments the element may communicate different signal types, such as electrical (e.g., thermoelectric) or mechanical (shear or tension forces). Also disclosed is a module incorporating a plurality of tanks to offer enhanced storage capacity.

In particular, some embodiments relate to a smart module used to store and/or transport bulk gases. The module comprises a plurality of gas storage pressure vessels supported by a container frame. Each tank within the module may incorporate (e.g., in an end connection) features such as an electrically- or pneumatically-actuated shut off valve, pressure and/or temperature sensors, and a pressure relief device. Each module may include sensors such as an accelerometer and/or GPS device, and a power source (e.g., panel of photovoltaic cells) and power storage unit (e.g., battery) configured to operate the sensors and/or pressure relief components. Module data transmitted wirelessly and stored remotely in a non-transitory computer readable storage medium, may be processed according to a computer-implemented method to reveal information such as a physical location of the container, a mass of stored gas, gas temperatures, gas pressures, cumulative number of fill cycles, and/or impact events resulting in damage to the tanks.

Certain embodiments are also directed to techniques for managing heat generated by filling a tank with gaseous material. According to one approach, a phase change material absorbs heat during a tank fill process. Conversion of phase change material from one state to another absorbs the heat arising during filling, allowing the process to proceed at an advanced rate. Upon removing gas from the tank, the phase change material converts back to its original state, surrendering heat to counteract cooling of the tank by gas expanding therein.

In some embodiments, the phase change material may comprise a liquid that undergoes a change between the liquid and the gas state. According to certain embodiments, the phase change material may comprise a solid that undergoes a change between the solid and the liquid state.

The phase change material can be selected according to one or more factors such as physical characteristics of the phase change material (e.g. reactivity with the gas and/or tank, boiling point, melting point, heat capacity, etc.) over pressure, density, and temperature ranges expected to be encountered during the tank filling process. Other possible factors for selecting the phase change material can include cost and ease/desirability of separation from the gaseous material (e.g., for reuse and/or to render the stored gaseous material suitable for its ultimate purpose or use).

In certain embodiments the tank itself may be designed such that one or more of its components and/or materials exhibit desirable thermal handling properties.

### BRIEF DESCRIPTION OF THE DRAWINGS

FIGS. 1A-1B are simplified views illustrating a compressed gas energy storage unit according to an embodiment.

FIGS. 2A-2E2 are simplified views of examples of compressed gas energy storage units according to various embodiments.

FIGS. 3-3A show a plurality of compressed gas storage units incorporated into a module according to an embodiment.

FIG. 3B is a simplified diagram of an alternative embodiment of a compressed gas storage module. FIG. 3C shows an enlarged view of the end connection of one of the pressure vessels of the module of FIG. 3A.

FIG. 4 shows a configuration utilizing two valves in parallel for tank filling.

FIG. 5 is a simplified flow diagram of a method according to an embodiment.

FIG. 6 shows a simplified perspective view of one embodiment of a tank support structure.

FIG. 6A shows a simplified enlarged view of the module of FIG. 1.

FIG. 7 shows configuring a module according to a particular transportation form factor.

FIG. 7A shows an enlarged view of the roof panel.

FIG. 7B shows a simplified cross-section of a photovoltaic cell.

FIG. 8 shows a simplified schematic view of a vessel end connection.

FIG. 9 shows a simplified view of a communications system.

FIG. 10 shows a pressure vessel system cooled using fans and side vents.

FIG. 11 is a simplified flow diagram of a method according to an embodiment.

FIG. 12 shows a simplified view of a sample computer system.

FIG. 12A is an illustration of basic subsystems in computer system of FIG. 12.

FIG. 13 is simplified view illustrating an embodiment of a tank filling process.

FIG. 14 is simplified view illustrating an embodiment of a tank filling process.

FIG. 15 is simplified view illustrating an embodiment of a tank filling process.

FIG. 16 is simplified cross-sectional view illustrating a standard transport container configured to house multiple tanks.

FIG. 17 is a simplified view of a tractor-trailer rig showing an overview of possible safety features.

FIG. 18 is simplified cross-sectional view illustrating an embodiment of a transport module.

FIG. 19 is simplified cross-sectional view illustrating a trailer according to an embodiment including an access port for acoustic emission testing.

FIG. 20 is a perspective view of a control box according to an embodiment.

### DESCRIPTION

The following documents are incorporated by reference in their entireties herein for all purposes: U.S. Patent Publ. 2011/0115223; U.S. Patent Publ. 2013/0098027; U.S. Patent Publ. 2013/0186597; and U.S. Patent Publ. 2013/0192216.

Various jurisdictions prescribe specific safety requirements for tanks configured to contain compressed gases at high pressures. One such requirement is that the tank release its contents in a controlled and safe manner in the event of a fire.

Embodiments are thus directed to compressed gas storage units exhibiting one or more safety features. Particular embodiments employ a pressure relief mechanism to rapidly yet safely vent the contents of the tank in the event of a fire. The mechanism may comprise an internally piloted relief valve in communication with temperature-sensitive element(s) running along the dimensions of the tank. Under high temperature conditions indicative of a fire, the element communicates a signal to open internally piloted relief valve. In some embodiments the element is configured to communicate a heat signal (e.g., by thermal conduction). In certain embodiments the element is configured to communicate a pressure change signal (e.g., pneumatic, hydraulic). In other embodiments the element may communicate different types of signals, such as electrical (e.g., thermoelectric) or mechanical (e.g., shear or tension forces).

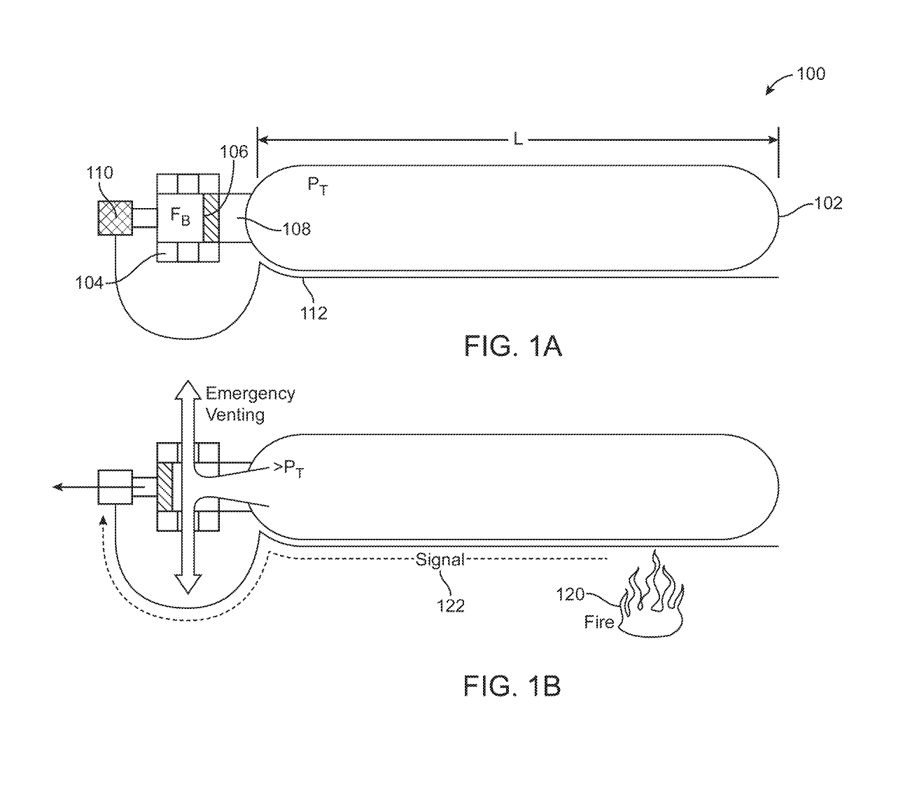

FIG. 1A shows one embodiment of a system 100 for storing compressed gas under normal conditions. Specifically, tank 102 contains a volume of compressed gas at a high tank pressure P_{T}.

Pressure relief device 104 comprising moveable member 106, is affixed to boss 108 at one end of the tank. Under the normal conditions shown in FIG. 1A, an extant balancing force F_{B} constrains movement of the member to maintain the relief device closed.

For example, in particular embodiments the pressure relief device may comprise an internally piloted valve, where F_{B} comprises the combination of an internal pressure and the force of a spring. Under the normal conditions shown in FIG. 1A, a release device 110 functions to seal the relief device, maintaining the internal pressure and the relief device in its closed state.

FIG. 1A, however, also shows the release device in communication with a temperature-sensing element 112 running an entire length L of the tank. In the event of a fire, element 112 is configured to communicate a signal to the release device.

Accordingly, FIG. 1B shows a simplified view of the system 100 of FIG. 1A with a fire 120 present. In response to the high temperatures associated with the nearby fire, the element 112 communicates a signal 122 to the release device.

In certain embodiments, the signal communicated by the temperature-sensing element may be thermal in nature. For example, the fire sensing element could comprise a solid material (e.g., in the shape of a wire or paddle) having a high thermal conductivity (e.g., copper), such that the heat of the fire is rapidly communicated along the element to the release device. In another example, the element could comprise a liquid having efficient thermal transmission characteristics. In some embodiments the temperature could be communicated by a material undergoing a phase change (e.g., a heat pipe).

In some embodiments, the signal communicated by the temperature-sensing element may be pressure-based. For example, the element could comprise a tube sealed to contain a material at some pressure greater than ambient. Upon exposure to the high temperature of the file, seal(s) of tube may be ruptured (e.g., soften or even liquefy, as in the case of a eutectic metal or wax), resulting in equalization of the pressure within the tube. Such a pressure change is communicated through the element to trigger operation of the release device.

In certain embodiments the contents of the sealed tube may comprise material(s) exhibiting desirable fire suppression characteristics. Examples can include but are not limited to gases (including relatively inert gases such as noble gases, nitrogen, and/or carbon dioxide), liquids such as water, and/or foams.

In various embodiments, the signal communicated by the temperature-sensing element may be mechanical in nature, such as a tension or shear force. A fire-sensitive element comprising bi-metallic materials may be useful for this purpose.

In particular embodiments, the signal communicated by the temperature-sensing element may be electrical in nature. Such a signal may be provided by a power source (battery, etc.), or may be a product of the fire itself, such as thermocouples arranged in series, or thermo-electric generator(s) mentioned later below.

In certain embodiments, the signal may be communicated by a combination of force types. For example, in a pressure-based element the tube plug may comprise a bi-metallic material whose changed shape ruptures the seal.

Irrespective of the particular form of the signal, the release device responds to it to actuate the relief device. For example in certain embodiments the release device may itself comprise a thermally sensitive material, such as a eutectic metal liquefying in response to a heat signal communicated by the fire sensitive element. In other embodiments the release device may comprise an element displaceable in response to a pressure signal (e.g. diaphragm) or in response to an electrical signal (e.g., solenoid).

Further details regarding a compressed gas storage units exhibiting safety features according to various embodiments, are now provided in connection with the following specific examples.

### Example 1

### Heat Conductor

A first example of a compressed gas storage unit is now presented in connection with a filament wound tank comprising a plastic liner approximately twenty-five (25) feet in length. Under the fire conditions of this example, the tank is to activate within 30-60 seconds upon sensing temperature rise, in order to vent its contents at >30,000 SCFM (standard cubic foot per minute).

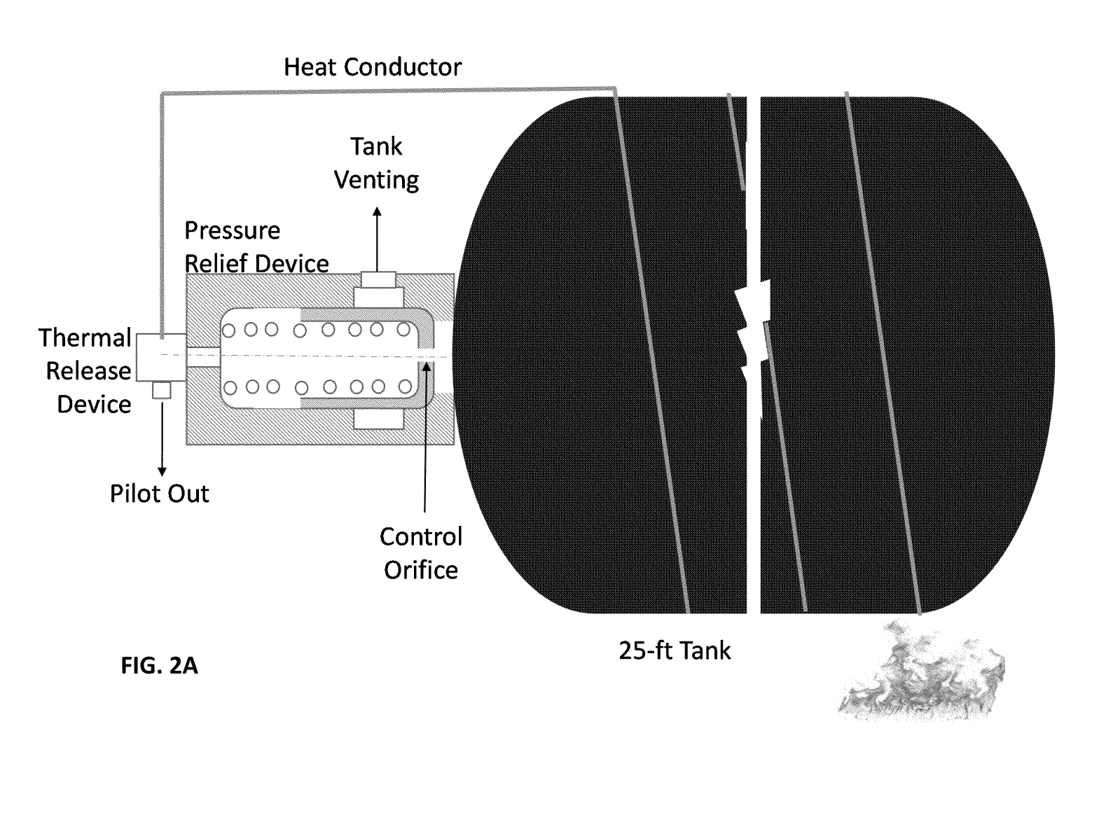

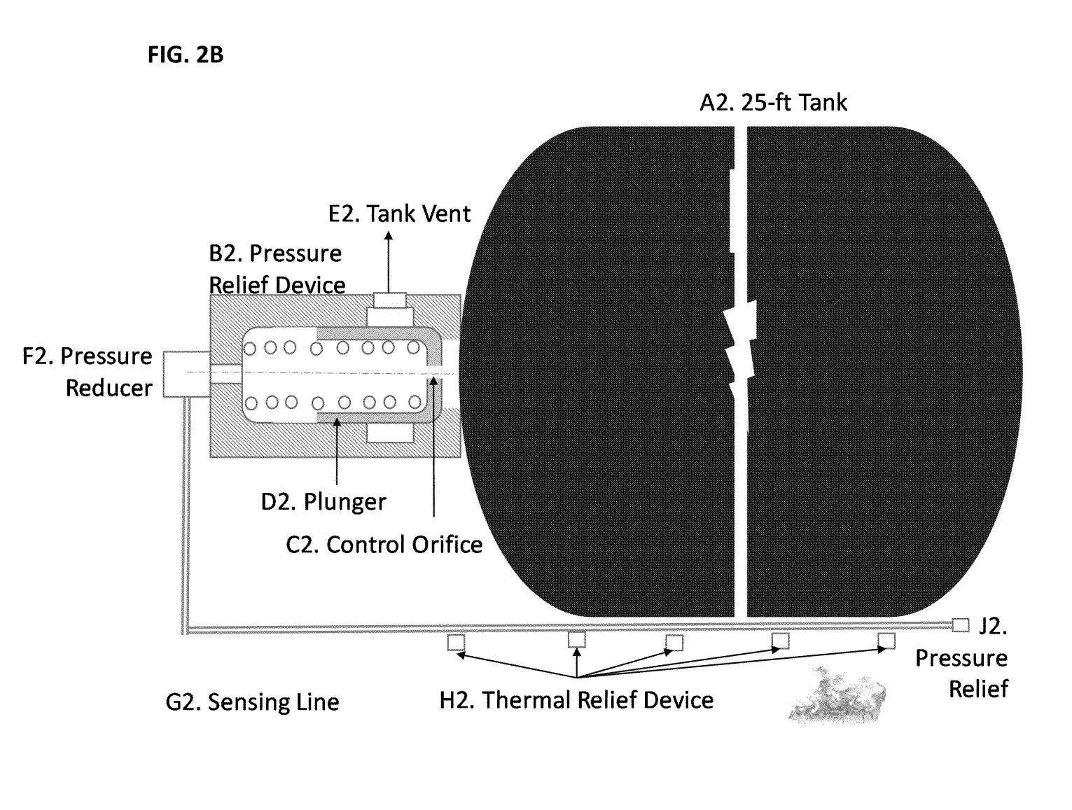

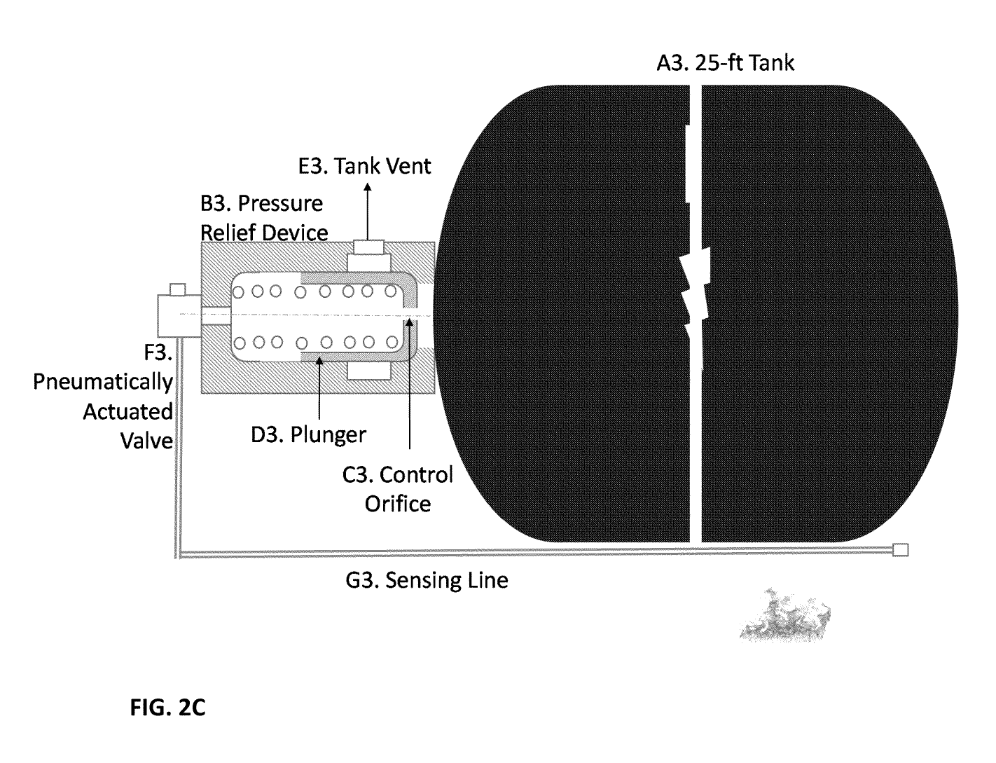

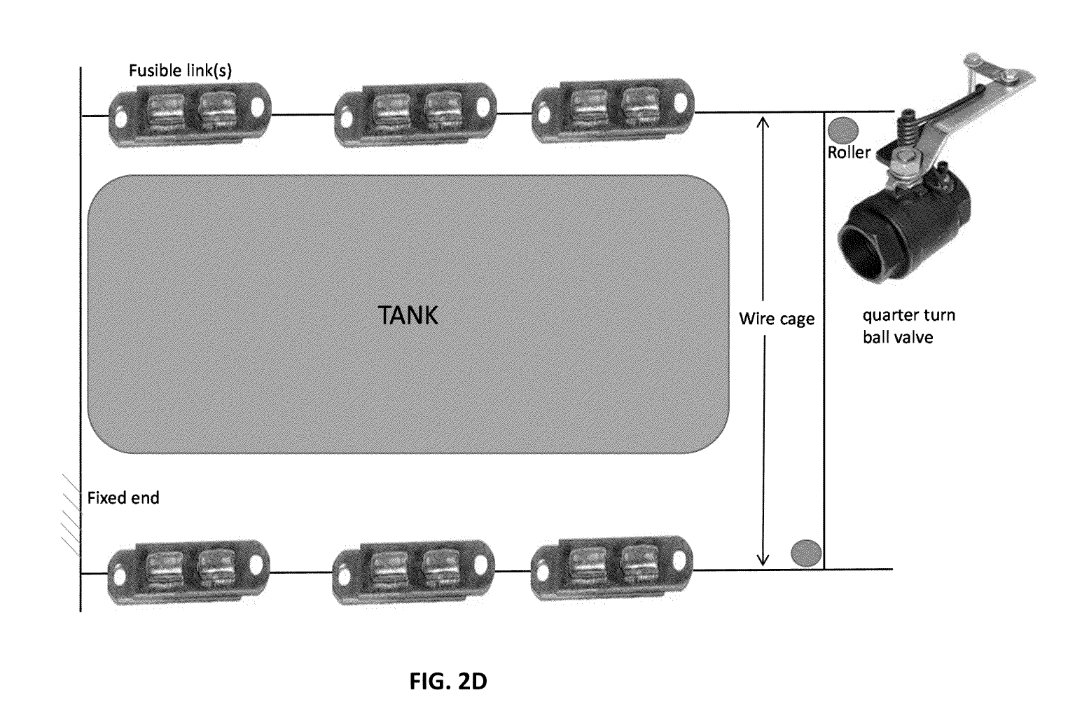

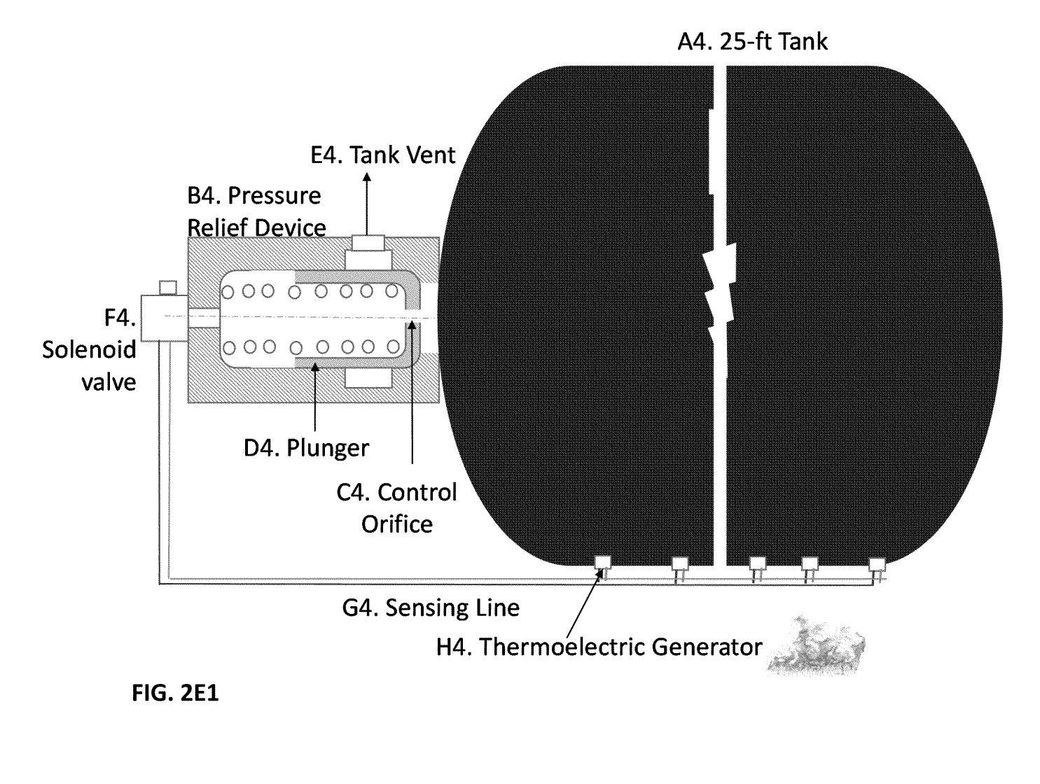

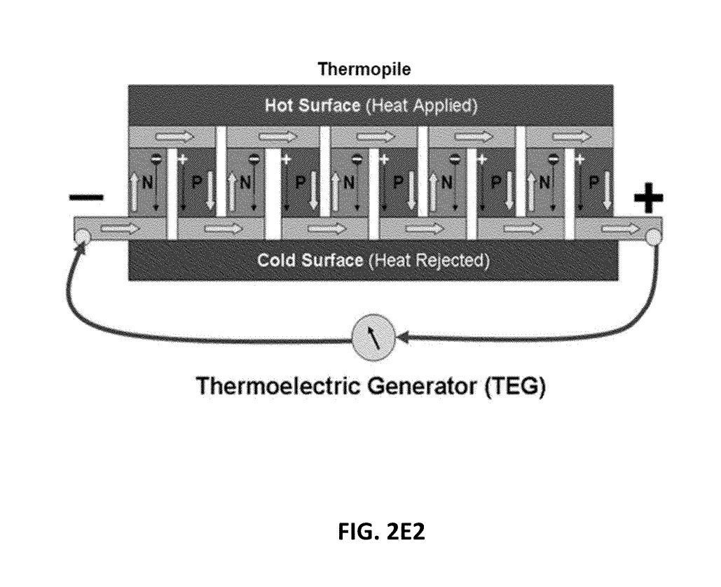

FIG. 2A shows a simplified view of this example. Here, the fire-sensitive element comprises a heat conductor coiled around the exterior of the filament wound tank. A thermal release device is in communication with the element.

Under normal conditions, the pressure release device is maintained in the closed position by a balancing force comprising the combination of a spring bias and an internal pressure corresponding to the tank pressure (as allowed to pass through a control orifice within the moveable member).

Upon receiving a thermal signal from the element indicating a fire, however, the release device unseals the relief device, significantly reducing the internal pressure. This in turn allows the moveable member to move rapidly to open the relief device, such that gas within the tank is vented through the side ports in the desired manner.

### Example 2

### Pressure Line

A second example of a compressed gas storage unit is now presented in connection with FIG. 2B. This example utilizes a pilot activated pressure relief valve in combination with a sensing line populated with temperature relief devices and a pressure reducer.

In particular, FIG. 2B shows composite pressure vessel A2 containing high pressure gas (e.g., up to 20,000 psi). The tank is to be protected against exposure to elevated temperatures, for example in a fire.

The tank is to be quickly relieved of internal pressure to prevent rupture from degradation of the composite wall. This is accomplished utilizing pressure relief device B2.

The pressure relief device B2 has a control orifice C2 which balances pressure on either side of the plunger D2. If pressure drops on the downstream side (the spring side) of the plunger, the plunger will compress the spring and cause the tank to vent quickly through the exposed tank vent E2.

The downstream (spring side) of the pressure relief device B2 is connected to an optional pressure reducer F2 which flows into a fire sensing line G2. Normally this line is sealed and there will not be a pressure drop on the downstream side of the pressure relief device B2.

However, if one of the thermal relief devices H2 is exposed to high temperature and/or fire, a seal is broken allowing a flow of gas through the fire sensing line G2. This flow results in a pressure imbalance in the pressure relief device B2, causing it to vent the tank quickly through tank vent E2. The pressure reducer F2 shields the sensing line from the full gas pressure within the tank, if pressurized lines outside of the tank are deemed unsafe. This device, therefore, is not essential in all embodiments. The pressure reducer, in its simplest form, has a spring, a diaphragm, and a pintle. Incoming gas pushes on the diaphragm, which is resisted by the spring, thus regulating the gas flow. The pintle opens and closes to regulate the pressure downstream of the pressure reducer.

In certain embodiments, the contents of the fire sensing line may include materials, e.g., water, carbon dioxide, foam(s), exhibiting desirable fire suppression properties. Rupturing the seal of the line, frees the contents of the line for release and exposure to the fire, aiding in its suppression and/or extinguishing.

### Example 3

### Pneumatic Actuator

A third example of a compressed gas storage unit is now presented in connection with FIG. 2C. This example utilizes a pilot activated pressure relief valve in combination with a pneumatic actuator and a sensing tube filled with an expanding fluid.

In particular, FIG. 2C shows the downstream (spring side) of the pressure relief device B3 connected to a pneumatically actuated valve F3. That valve can be actuated by pressure from the sensing line G3, which is filled with a fluid such as ethylene glycol/water or carbon dioxide, which is specifically tailored to expand significantly when exposed to a pre-set temperature, for example 200 degrees F.

When the sensing line G3 is exposed to fire or elevated temperature, pressure builds up, which results in actuation of the pneumatic valve F3 and release of downstream pressure from B3. This results in a pressure imbalance in the pressure relief device B3, causing it to vent the tank quickly through tank vent E3.

In these examples 1 through 3, the pilot activated relief valve may perform dual functions. It may be sensitive to the signal communicating an over-temperature condition, and also to over pressure in the tank. It may be configured so as to open under either of these conditions.

### Example 4

### Fusible Link

A fourth example of a compressed gas storage unit is now presented in connection with FIG. 2D. This example utilizes one or more fusible links in communication with a quarter turn ball valve.

In particular FIG. 2D shows a quarter-turn ball valve that is spring-loaded shut and installed in the inlet header. This serves as the temperature relief valve.

Ball valves desirably exhibit a high flow coefficient (Cv). This allows use of a small valve in order to satisfy relief requirements.

A pin or fuse is used to unload the spring, causing the valve to open when a fire is sensed.

A wire “cage” is constructed around the tank with the appropriate spacing. In some embodiments the wire is a fusible chain.

In certain embodiments the wire is constructed from fusible links in series at a pre-determined distance. Fusible links may be obtained with different temperature triggers and/or tension specifications.

The array of multiple wires are connected together and combined to a single wire that is linked to the spring mechanism on the valve. This can be accomplished by the use of rollers or pulleys.

The wire in tension keeps the valve closed. In the event of a fire the fusible link breaks, releasing the tension in the wire and causing the valve to open. Thus when the link is broken by a fire, the valve opens and the tank contents are discharged at a high rate.

When there is insufficient tension in the wires the valve will remain open, preventing the filling of a tank which does not have a working fire-safety mechanism in place. This also offers a useful safety feature. The wires can be routed through protective channels such that they are exposed to high temperature indicative of a fire, while protected from mechanical damage.

### Example 5

### Thermoelectric Generator

A fifth example of a compressed gas storage unit is now presented in connection with FIGS. 2E1-2. This example utilizes an electrical signal from a thermoelectric generator.

In FIG. 2E1, the downstream (spring side) of the pressure relief device (B4) is connected to an electric solenoid valve (F4). That solenoid valve can be actuated by electricity from the thermoelectric generator H4, disposed along the sensing line G4.

When the sensing line (G4) comprising an electric conductor is exposed to fire or elevated temperature, the thermoelectric generator(s) (H4) will generate a DC voltage, thus activating the solenoid valve (F4). This results in a pressure imbalance in the pressure relief device (B4), causing it to vent the tank quickly through tank vent (E4). Sensing line G5 is protected from damage by fire so as to survive long enough to communicate a signal to valve F4. While F4 has been described as a solenoid valve, it may be a latching valve or it may be another form of electrically actuated valve such as a motor driven ball valve.

Examples of thermoelectric generators which may be used according to embodiments, can include but are not limited to a thermocouple (including an array thereof—a thermopile), and a metal eutectic salt thermal battery.

A high temperature galvanic primary cell incorporates a eutectic electrolyte. A thermal battery comprises a single use high temperature galvanic primary cell.

They contain a metallic salt electrolyte which is non-conducting when solid at ambient temperature but which is an excellent ionic conductor when molten. Activated by elevated temperatures, they provide a high burst of power for a short period (e.g., a few tens of seconds to 20 minutes or more).

They are rugged and safe with a long shelf life in storage which makes them well-suited for gas transportation applications.

Typical chemistry is Lithium Iron disulphide. The electrolyte is normally a eutectic mixture of lithium and potassium chlorides. Power output ranges from a few watts to several kilowatts.

Such embodiments may offer one or more benefits, including but not limited to an ability to withstand mechanical stresses of acceleration, shock, vibration, and spin (e.g., as may be encountered during transport, including in accident scenarios giving rise to fires). Other possible advantages can include high power and energy densities, and quick activation.

Active chemicals are inert until activated, and the device exhibits a long unactivated shelf life. The design can be optimized for power or capacity.

Since the energy available from a single thermocouple is small, arrays of thermocouples can be used to construct thermocentric devices capable of handling practical amounts of power. Higher power devices can be made by connecting thermocouples in series to increase the voltage capacity and in parallel to increase the current capacity. Such an array of thermocouples is a thermopile. A simplified view of a thermopile is shown in FIG. 2E2.

Thermoelectric generators can be used in much the same way as photovoltaic devices and in the same way electrical ancillary circuits can be used. For example higher voltage outputs can be achieved by using the array to drive a DC/DC converter.

Seebeck effect thermopiles are used to convert heat energy into electrical energy in thermoelectric generators (TEGs) with electrical power outputs of 1000 watts or more.

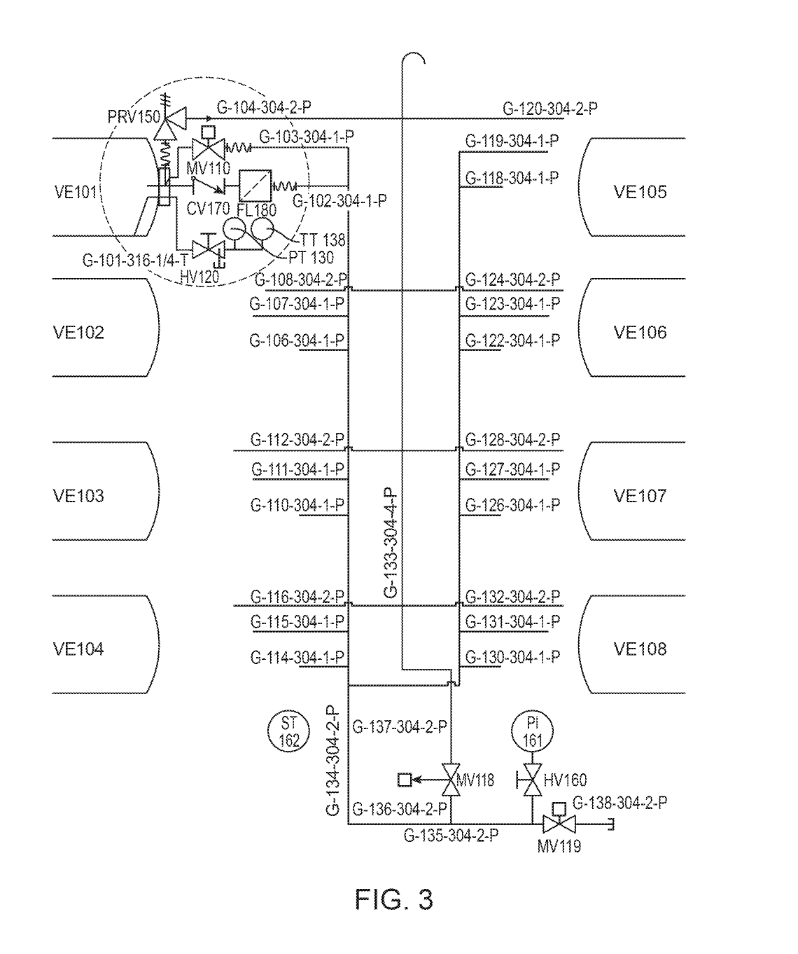

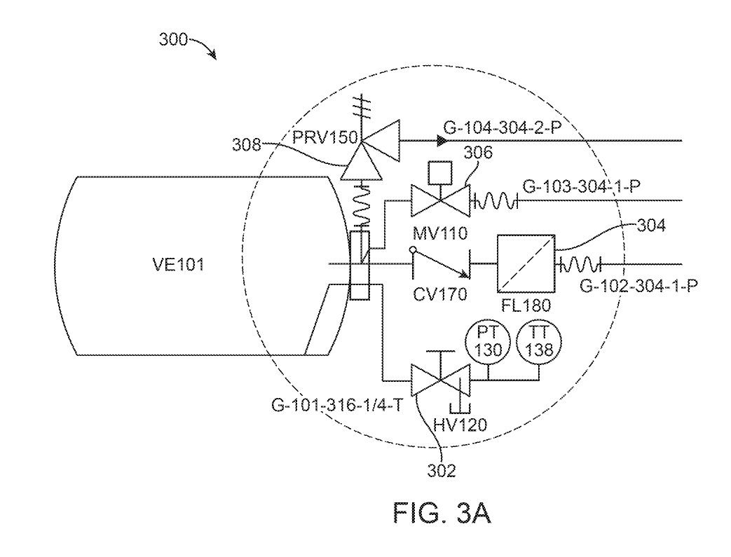

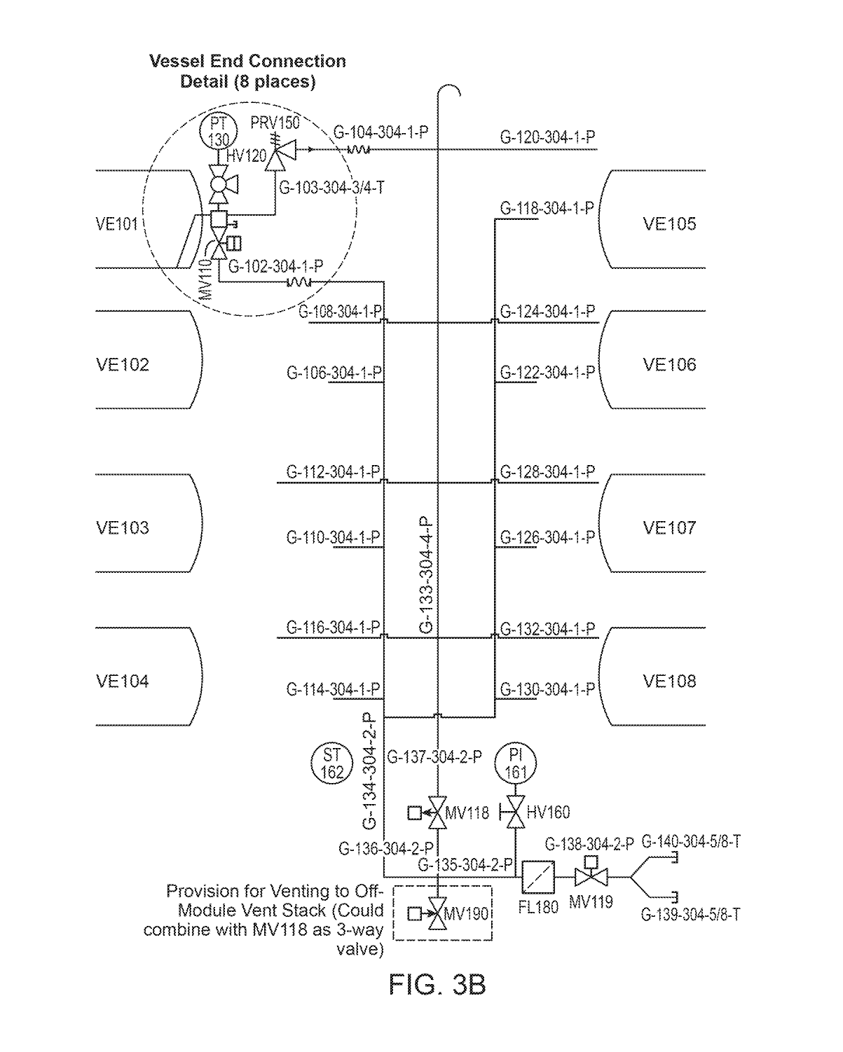

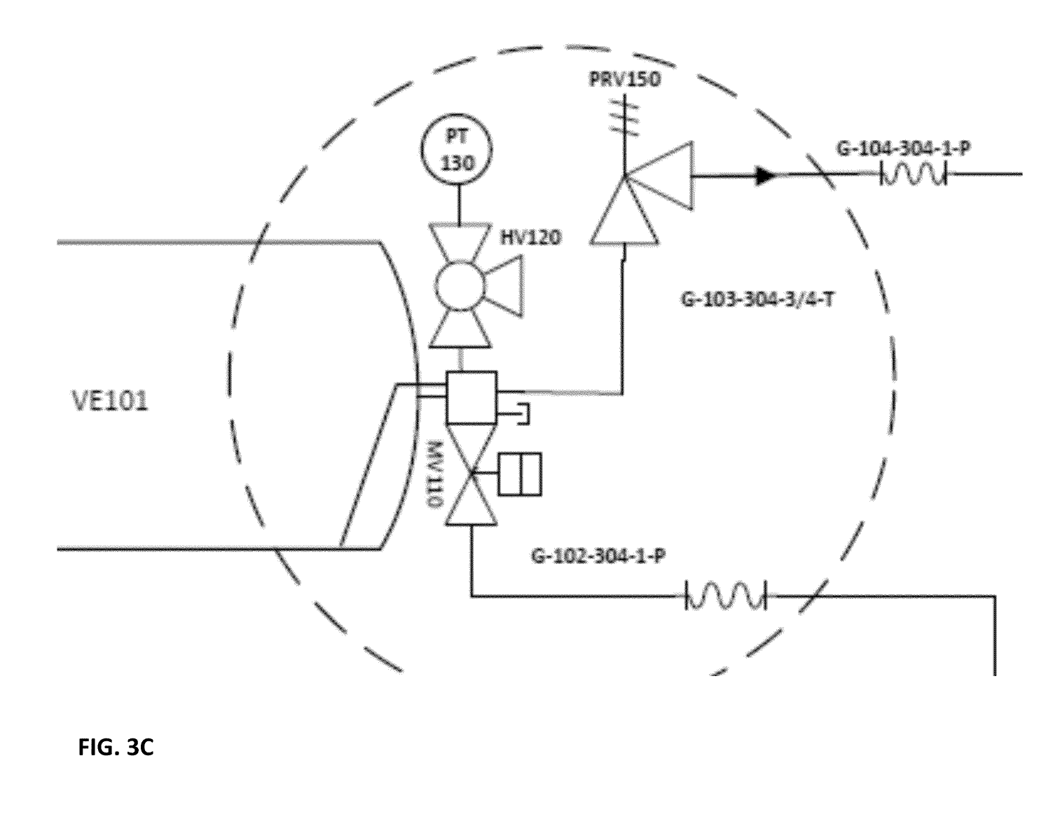

Embodiments of compressed gas storage units can be incorporated within an overall module structure offering a larger compressed gas storage capacity. FIG. 3 is a simplified diagram of such a module, comprising eight storage tanks (VE101-VE108) configured to store compressed gases such as CNG, hydrogen, helium, nitrogen, air, carbon dioxide. Each tank is filled through a high flow check valve, and discharged through electric solenoid valves. Individual solenoid valve on each tank allows an operator to discharge all tanks simultaneously or in a stepwise fashion to optimize the discharge flow rate for the application. Each tank and the module are also provided with pressure sensors and thermocouples to measure the internal gas pressure and temperature. The gas pressure and gas temperature can be used to estimate the mass of stored gas at any time, which may be wirelessly transmitted in real-time, and also used to prevent filling of the tank and notify the user, if unsafe pressure or temperature values are detected.

Here, a pressure of the gas source during refueling is 4,531 psi at 70° F. The minimum pressure in the tank is 0-360 psi.

A gas temperature range is from −40 to 150° F. An occasional excursion to −150° F. is possible if the tank is empty and at −40° F., and the source gas is also at −40° F.

The ambient temperature range is from −40 to 135° F. The density of the gas mixture is 0.04452 lb/ft³ at 70° F. The target time fill from empty to 3,600 psi is 1 hour=1000 SCFM.

FIG. 3A shows an enlarged view of the end connection 300 of one of the pressure vessels (VE101) of FIG. 3. Several valve configurations are shown in this FIG. 3A.

The valve configuration 302 corresponds to a manually operated valve positioned between the pressure vessel and pressure and temperature sensors. The valve is normally open, allowing the sensors full exposure to the compressed gas that is stored in the pressure vessel. The manual valve allows servicing or replacement of the pressure or temperature sensors without emptying the contents of the pressure vessel. Downstream of the manual valve is a drain plug that allows periodic emptying of any water or sludge that may accumulate within the pressure vessel, through a straw that is configured to suction out water or sludge.

The valve configuration 304 corresponds to a check valve and a high flow gas filter. The check valve allows fast-filling of the pressure vessel at high flow rates, without having to manually or electrically opening a valve. The filter prevents particulates and other contaminants from damaging the check valve, and entering the pressure vessel.

The valve configuration 306 corresponds to a manual or electric solenoid valve with a high flow coefficient (Cv) for opening the pressure vessel to discharge the compressed gas for utilization.

The valve configuration 308 corresponds to the pressure relief valve 304 that allows a safe, but quick discharge of the contents of the pressure vessel in case of an unsafe condition such as high temperature exposure in a fire.

FIG. 3B is a simplified diagram of an alternative embodiment of a compressed gas storage module. FIG. 3B shows an enlarged view of the end connection of one of the pressure vessels (VE101) of the module of FIG. 3A.

Details regarding certain valves in this particular embodiment are now provided. All pneumatically actuated valves except MV118 are to be normally closed. MV118 is normally open.

PRV150 inlet and discharge lines are to consider PRV reaction forces in order to limit transfer of reaction forces into the vessel end fitting. PRV150 shall have thermal relief capabilities as well as over pressure protection. It is permissible to separate out this functionality to multiple devices.

MV110 is a multiport valve. It has one inlet connection that connects to the tank end fitting. It has three outlet ports that are in communication with tank pressure at all times. It has one outlet port that is in communication with line pressure and must be actuated open to communicate with tank pressure.

The inlet of the line from HV120 into the tank is to provide a way of measuring pressure via PT130. It also allows manually draining any accumulating liquid in the tank.

A module comprising a plurality of compressed gas storage units may conform to one or more form factors and/or safety specifications for purposes of transport. Examples can include but are not limited to the following, each of which are incorporated by reference herein for all purposes:
U.S. Rail Tank Car specifications: Code of Federal Regulations, Title 49 (Transportation) Parts 200 to 299; DOT Pressure Tank Cars −105; AAR Manual of Standards and Recommended Practices (MSRP)C-III, Specification M-1002; International Standards Organization ISO 1496-3 Tank containers for liquids, gases and pressurized dry bulk;
Canadian Rail Tank Car specifications: Transport Canada CTC regulations; AAR Manual of Standards and Recommended Practices (MSRP)C-III, Specification M-1002; International Standards Organization ISO 1496-3 Tank containers for liquids, gases and pressurized dry bulk;
U.S. Tractor-trailer specifications: Code of Federal Regulations, Title 49 (Transportation) Parts 393 and 571; Compressed Gas Association TB-25 Design Considerations for Tube Trailers; International Standards Organization ISO 1496-3 Tank containers for liquids, gases and pressurized dry bulk;
Canadian Tractor-trailer and Shipping Container specifications: Transport Canada Transport of Dangerous Goods (TGD) Regulations Part 5; CSA B 620 Highway Tanks and TC Portable Tanks for the Transportation of Dangerous Goods; Compressed Gas Association TB-25 Design Considerations for Tube Trailers; International Standards Organization ISO 1496-3 Tank containers for liquids, gases and pressurized dry bulk;
European Tractor-trailer and Shipping Container specifications: European Directive 96/53/EC and the European Module System; International Standards Organization ISO 1496-3 Tank containers for liquids, gases and pressurized dry bulk.

According to various embodiments, compressed gas storage units may exhibit one or more of the following features. A tank support structure may have a ‘bulkhead’ safety cage to protect valves and sensors against impact damage. A trailer roof may be provided with a rooftop solar photovoltaic charging system and battery to power solenoidal valves and pressure release devices. The system may be set up to wirelessly transmit temperature, pressure and accelerometer data to notify operator that tanks have exceeded service life interval (and will need tank requalification) and/or if an impact event is detected. The temperature and/or pressure data may be used to estimate the mass of gas filled so that the truck is not overfilled. The tank system may be cooled by the use of solar powered fans and/or side vents.

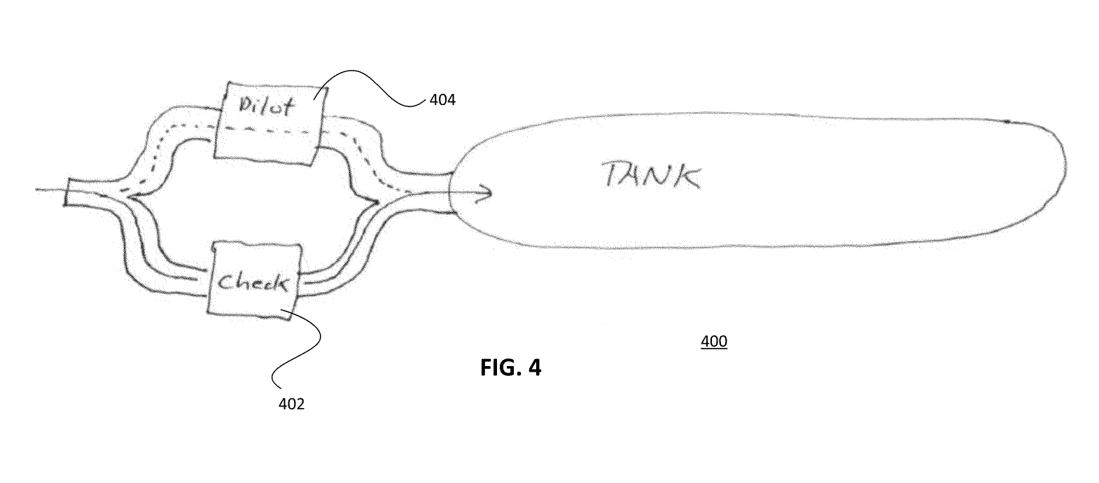

It is noted that other embodiments are possible. For example, FIG. 4 shows a configuration 400 utilizing two valves for tank filling. In particular, a check valve 402 and an internally piloted solenoid valve 404 are arranged in parallel.

Initially, the pressure in the tank is ambient. Compressed gas is flowed through the check valve into the tank, while the solenoid valve remains closed.

At a certain point, however, the pressure within the tank rises to the level such that the solenoid valve is opened. This affords an additional path to flow compressed gas into the tank more quickly.

Upon tank fill, when the tank pressure balances with the filling source the check valve closes, as does the solenoid valve. The solenoid valve can now be opened as required to discharge the tank to utilize the pressurized content of the tank.

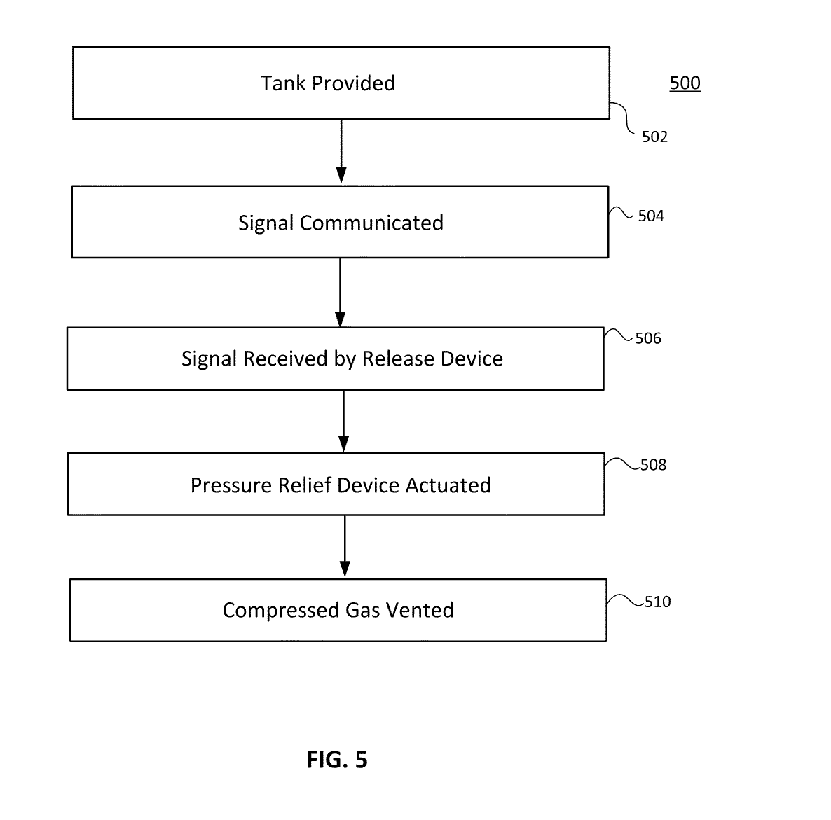

FIG. 5 shows a simplified flow diagram of a method 500 according to an embodiment. In a first step 502, a tank containing compressed gas is provided.

In a second step 504, a fire sensing element communicates a signal in response to a temperature change proximate to the tank. In a third step 506, a release device receives the signal.

In a fourth step 508, the release device actuates a pressure relief device. In a fifth step 510, compressed gas within the tank is vented through the pressure relief device.

The following clauses describe various embodiments.

1A. An apparatus comprising:

a tank configured to contain a compressed gas and having a boss;
a temperature-sensing element proximate to the tank and configured to communicate a signal in response to a temperature change; and
a pressure relief device positioned at the boss and configured to be actuated in response to receipt of the signal.

2A. An apparatus as in any of clauses 1A-20A further comprising a release device configured to receive the signal and actuate the pressure relief device.

3A. An apparatus as in any of clauses 1A-20A wherein the pressure relief device comprises a pilot valve.

4A. An apparatus as in clause 3A wherein the pilot valve is piloted by an internal pressure.

5A. An apparatus as in clause 4A wherein the internal pressure comprises a tank pressure.

6A. An apparatus as in any of clauses 1A-20A wherein the signal comprises a thermal signal.

7A. An apparatus as in clause 6A wherein a material of the release device is configured to undergo a phase change in response to the signal.

8A. An apparatus as in clause 7A wherein the material comprises a eutectic metal.

9A. An apparatus as in any of clauses 1A-20A wherein the temperature-sensing element comprises a heat pipe.

10A. An apparatus as in any of clauses 1A-20A wherein the signal comprises a pressure signal.

11A. An apparatus as in clause 10A wherein the pressure signal comprises a pressure decrease.

12A. An apparatus as in clause 11A wherein:

the temperature sensing element comprises a tube; and
the pressure decrease results from breaking a seal of the tube.

13A. An apparatus as in clause 12A wherein the tube contains a fire suppression material.

14A. An apparatus as in clause 10A wherein the pressure signal comprises a pressure increase.

15A. An apparatus as in clause 10A further comprising a release device configured to actuate the pressure relief valve, the release device comprising a pneumatic valve.

16A. An apparatus as in any of clauses 1A-20A wherein the signal comprises a mechanical force.

17A. An apparatus as in clause 16A wherein the temperature sensitive element comprises a fusible link.

18A. An apparatus as in clause 16A wherein the temperature sensitive element is bimetallic.

19A. An apparatus as in any of clauses 1A-20A wherein the signal is electrical.

20A. An apparatus as in clause 19A where the temperature sensitive element comprises a thermogenerator.

21A. A method comprising:

a temperature sensitive element proximate to a tank containing compressed gas, communicating a thermal signal in response to a temperature change;
a release device receiving the thermal signal; and
in response to the thermal signal, the release device actuating a pressure relief device to vent compressed gas from the tank.

22A. A method comprising:

a temperature sensitive element proximate to a tank containing compressed gas, communicating a pressure signal in response to a temperature change;
a release device receiving the pressure signal; and
in response to the pressure signal, the release device actuating a pressure relief device to vent compressed gas from the tank.

Various jurisdictions prescribe specific safety requirements for tanks configured to contain compressed gases at high pressures. Accordingly, embodiments are directed to a smart module for storage and transportation of gas.

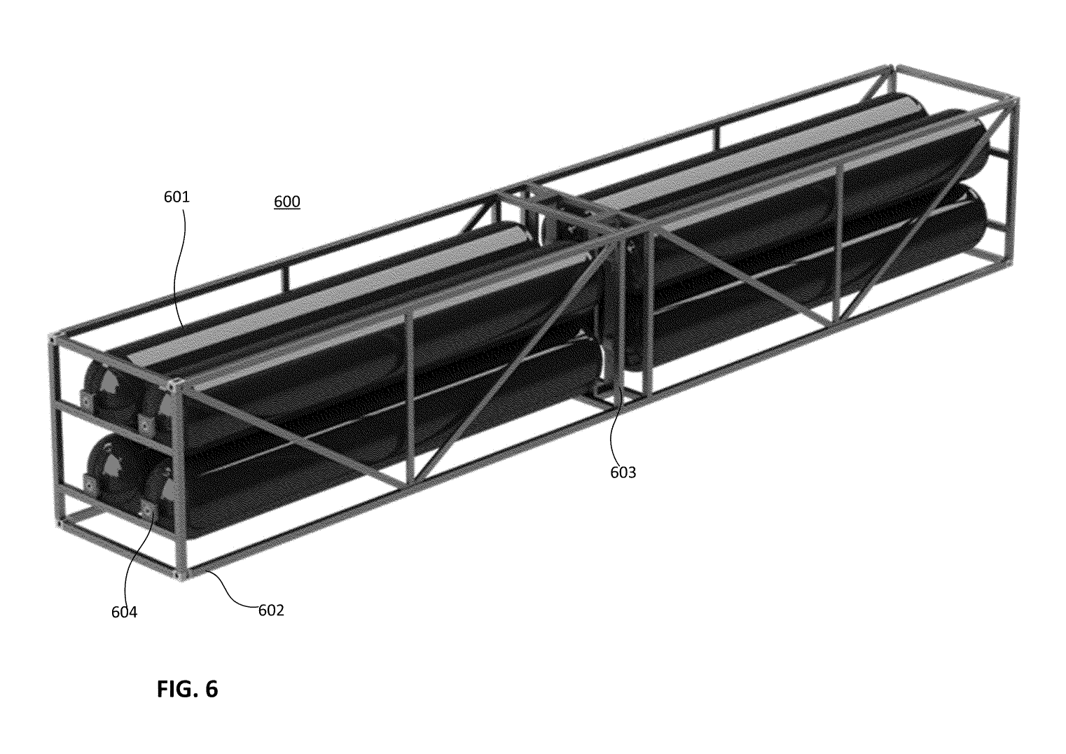

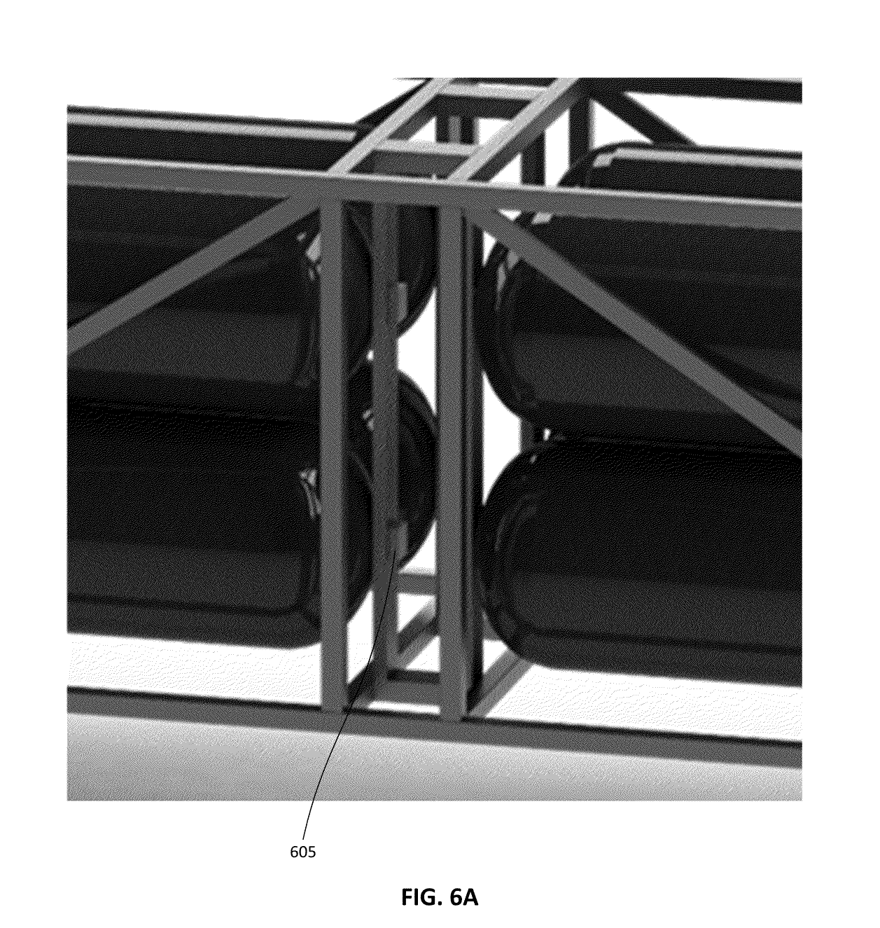

In particular, FIG. 6 shows a simplified perspective view of one embodiment of a tank support structure 600. Tank support structure has a ‘bulkhead’ safety cage to protect valves and sensors against impact damage.

Specifically, a number of gas storage pressure vessels 601 are supported by a container frame 602 for bulk transportation of gases (e.g., over the road on a tractor trailer, by rail, or by ship). Each tank may incorporate an electrically- or pneumatically-actuated shut off valve, pressure and/or temperature sensors, and a pressure relief device. One or more of these components are packaged into a manifold and housed at a rigid safety cage 3 at the center of the container.

FIG. 6A shows a simplified enlarged view of the module of FIG. 6. FIG. 6A shows each pressure vessel 601 supported by its ends.

The vessel end at the safety cage is fixed, and encased in a C-channel 605. The opposite end of the vessel 604 is supported such that it can move axially to accommodate axial expansion and contraction of the pressure vessel as it is filled and emptied.

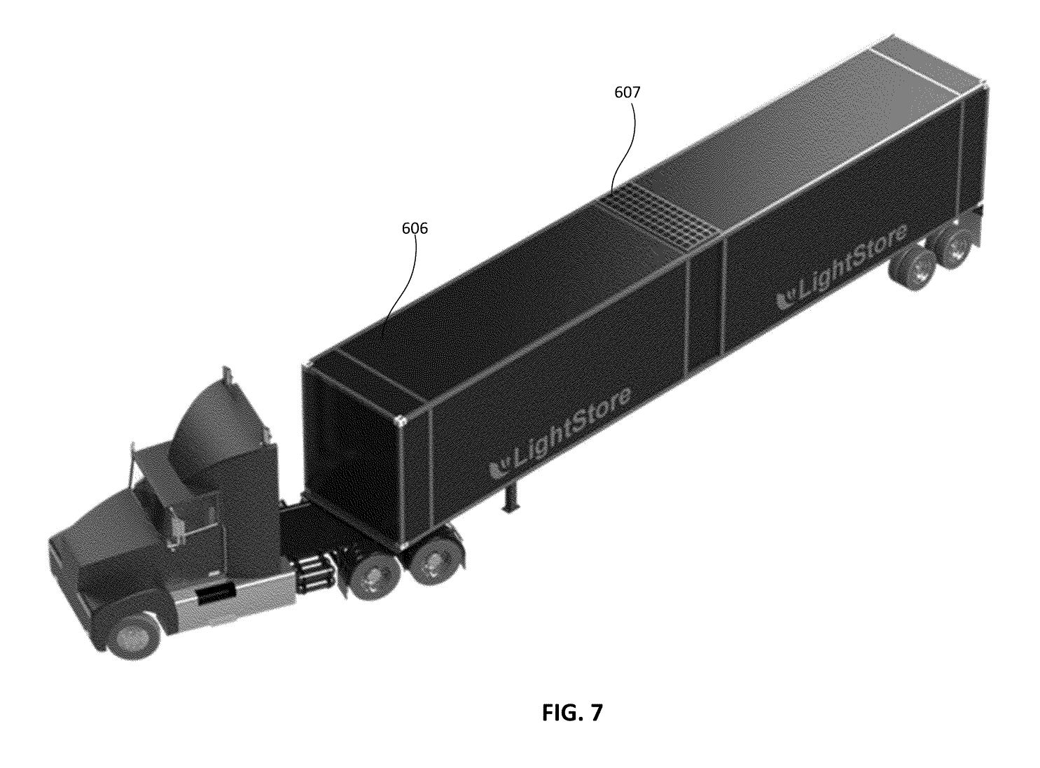

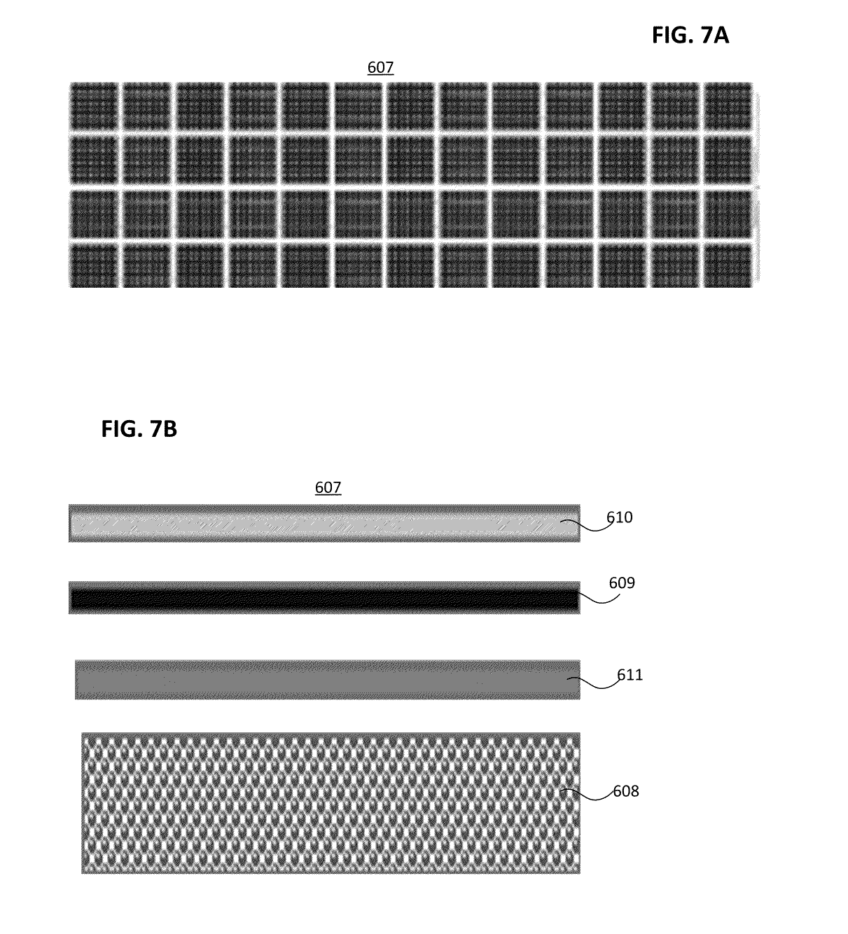

FIG. 7 shows configuring of a module according to a particular transportation form factor. Here, the module is within a trailer of a tractor trailer rig.

The container roof may be equipped with a solar photovoltaic charging system and/or storage battery to power the electric valves and pressure release devices. The system can be powered by the battery, which may be charged by solar PV and/or other sources.

For example, alternative energy sources can include but are not limited to batteries charged:
by an electrical system of the vehicle;
by scavenging energy from other sources (such as from road vibration); and/or
at filling/discharge stations.

Gas storage vessels are packaged in a container frame structure. In particular, the container 606 has a roof, which houses one or more solar photovoltaic panels 607 that generate electricity when exposed to light. Each panel can be rated (e.g., about 100-400 watts) depending on the conversion efficiency of the photovoltaic cells and the area of the panel.

The roof of a standard 40-ft or 53-ft ISO container can house enough panels to generate 5 kilowatts of power or about 30 kilowatt hour of energy per day.

The solar photovoltaic cells 609 can be integrated on to a roof panel 608, which can be made of lightweight fiberglass composite or honeycomb. FIG. 7A shows an enlarged view of the roof panel.

FIG. 7B shows a simplified cross-section of a photovoltaic cell. The cells are covered by a protective glass or plastic sheet 610, and bonded to the substrate 608 (here the roof panel) utilizing an adhesive layer 611. Electricity generated by the solar panel(s) is stored in a battery that is housed in the container 606. Electrical connections may be explosion-proofed for applications involving gaseous fuels such as hydrogen or natural gas.

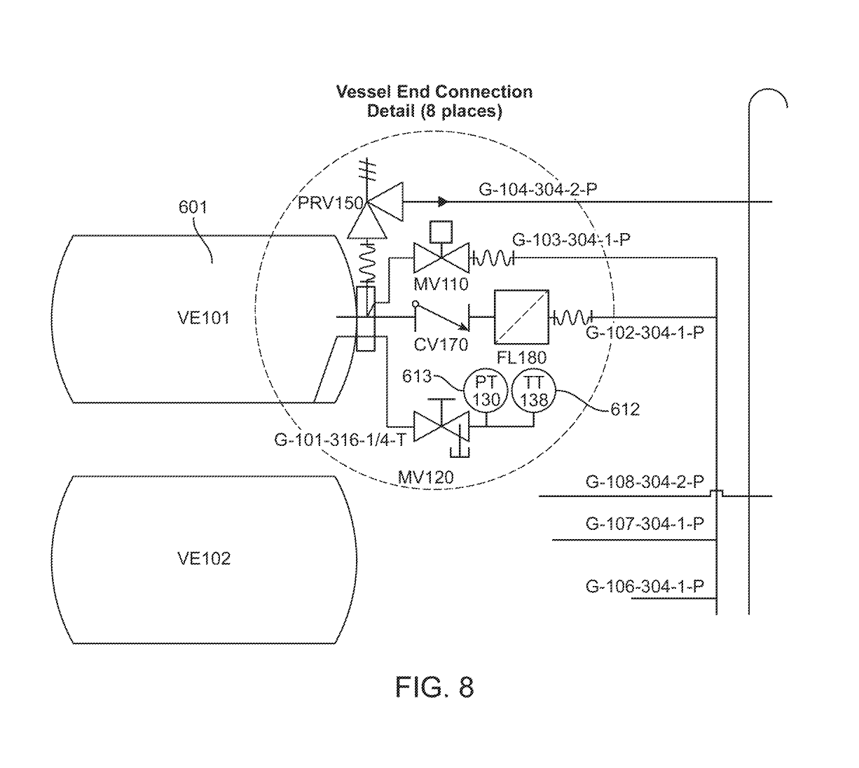

The system may be set up to wirelessly transmit temperature, pressure, location, and/or accelerometer data for further analysis and dissemination. In particular, FIG. 8 shows a schematic view of a vessel end connection.

Each gas storage vessel 601 is connected to a thermocouple 612 and pressure transducer 613. This allows for monitoring the temperature and/or pressure of gas within the vessel on an ongoing basis.

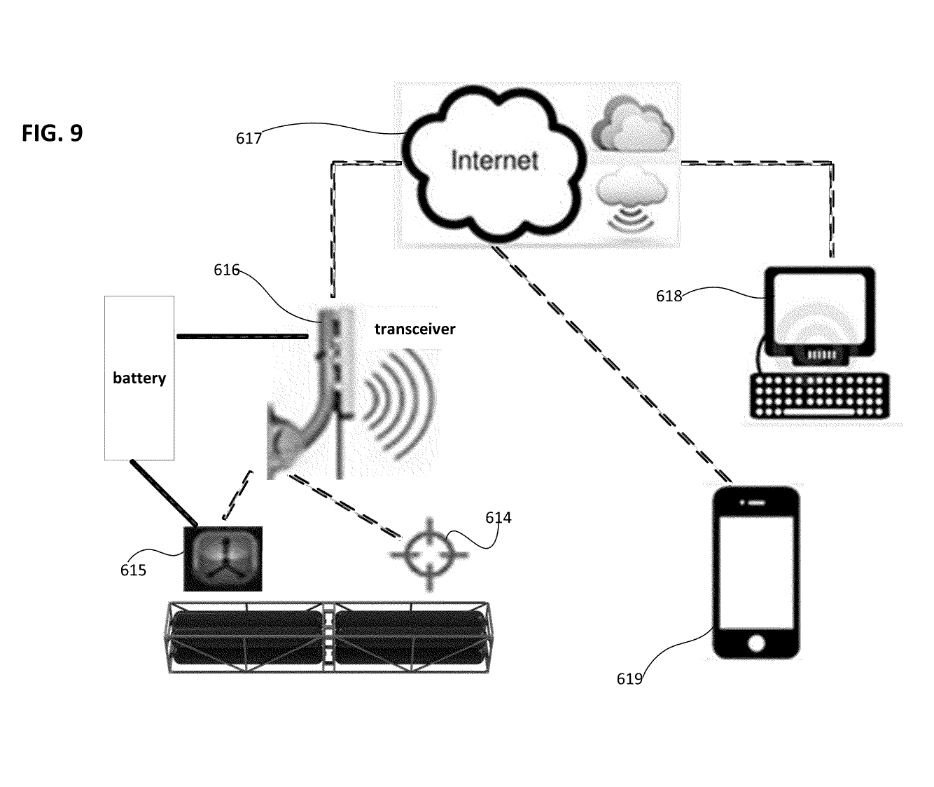

FIG. 9 shows a simplified view of the communications system. The accelerometer 614 affixed on the container structure monitors for impact events. The Global Positioning System (GPS) device 615 monitors the physical location of the container.

The collected data is transmitted wirelessly by a transmitter 616 to an Internet ‘cloud-based’ database 617. That collected data may be analyzed using software 618.

In particular, embodiments of systems and methods for compressed gas storage are particularly suited for implementation in conjunction with a host computer including a processor and a non-transitory computer-readable storage medium. Such a processor and non-transitory computer-readable storage medium may be embedded in the apparatus, and/or may be controlled or monitored through external input/output devices.

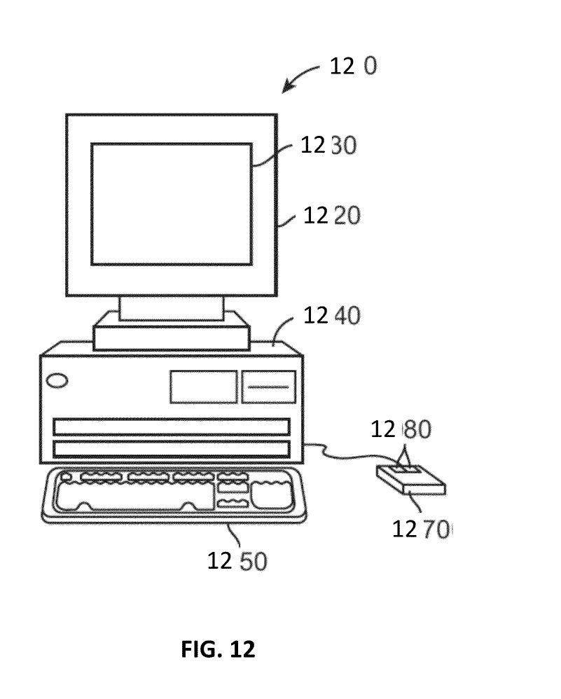

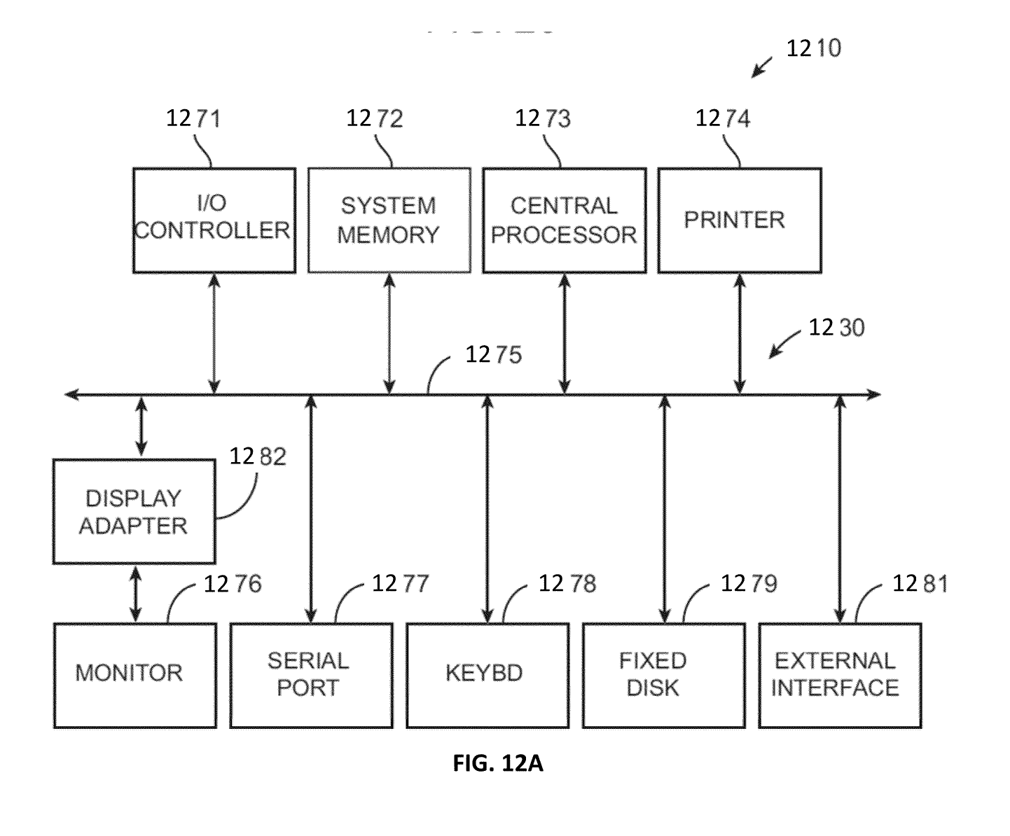

FIG. 12 is a simplified diagram of a computing device for processing information according to an embodiment. This diagram is merely an example, which should not limit the scope of the claims herein. One of ordinary skill in the art would recognize many other variations, modifications, and alternatives. Embodiments can be implemented in a single application program such as a browser, or can be implemented as multiple programs in a distributed computing environment, such as a workstation, personal computer or a remote terminal in a client server relationship.

FIG. 12 shows computer system 1210 including display device 1220, display screen 1230, cabinet 1240, keyboard 1250, and mouse 1270. Mouse 1270 and keyboard 1250 are representative “user input devices.” Mouse 1270 includes buttons 1280 for selection of buttons on a graphical user interface device. Other examples of user input devices are a touch screen, light pen, track ball, data glove, microphone, and so forth. FIG. 12 is representative of but one type of system for embodying the present invention. It will be readily apparent to one of ordinary skill in the art that many system types and configurations are suitable for use in conjunction with embodiments according to the present invention.

As noted, mouse 1270 can have one or more buttons such as buttons 1280. Cabinet 1240 houses familiar computer components such as disk drives, a processor, storage device, etc. Storage devices include, but are not limited to, disk drives, magnetic tape, solid-state memory, bubble memory, etc. Cabinet 1240 can include additional hardware such as input/output (I/O) interface cards for connecting computer system 1210 to external devices external storage, other computers or additional peripherals, further described below.

FIG. 12A is an illustration of basic subsystems in computer system 1210 of FIG. 12. This diagram is merely an illustration and should not limit the scope of the claims herein. One of ordinary skill in the art will recognize other variations, modifications, and alternatives. In certain embodiments, the subsystems are interconnected via a system bus 1275. Additional subsystems such as a printer 1274, keyboard 1278, fixed disk 1279, monitor 1276, which is coupled to display adapter 1282, and others are shown. Peripherals and input/output (I/O) devices, which couple to I/O controller 1271, can be connected to the computer system by any number of approaches known in the art, such as serial port 1277. For example, serial port 1277 can be used to connect the computer system to a modem 1281, which in turn connects to a wide area network such as the Internet, a mouse input device, or a scanner. The interconnection via system bus allows central processor 1273 to communicate with each subsystem and to control the execution of instructions from system memory 1272 or the fixed disk 1279, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

Based upon inputs received from a gas storage and transport module, a controller may perform various processing tasks to produce relevant outputs. The results of such analysis/processing of data communicated from a gas storage and transport module according to an embodiment, can include one or more of the following:
a physical location of the container;
mass of stored gas available to be dispensed;
gas temperatures, and whether allowable limits have been exceeded;
gas pressures, and whether maximum allowable pressures are exceeded;
cumulative number of fill cycles, and whether tank requalification or retirement is required;
occurrence of an impact event that may have damaged the tanks.

The results of the analysis can be conveniently accessed wirelessly by the truck operator or others, using devices 619 (such as smart phones, tablets, laptops, or other types of computers).

Access to such information may be password protected and only available to paid subscribers. Transmitted data may be encrypted for further security.

Data may be transmitted using cellular phone data links, satellite data links, WiFi, or proprietary links. Where communication coverage is intermittent, data may be stored for later transmission when a communication link is available.

It is noted that the data transmitted by the module (e.g., gas mass, location, refill cycle no., others) can be used to match end users with suitable module(s) and/or module operators. For example, where a calculation of gas mass data occurs at the module itself (e.g., by an embedded processor), this could allow a peer-to-peer network matching gas buyers with particular sellers. A network comprising centralized server(s) in communication with a plurality of remote clients, could also perform such a role.

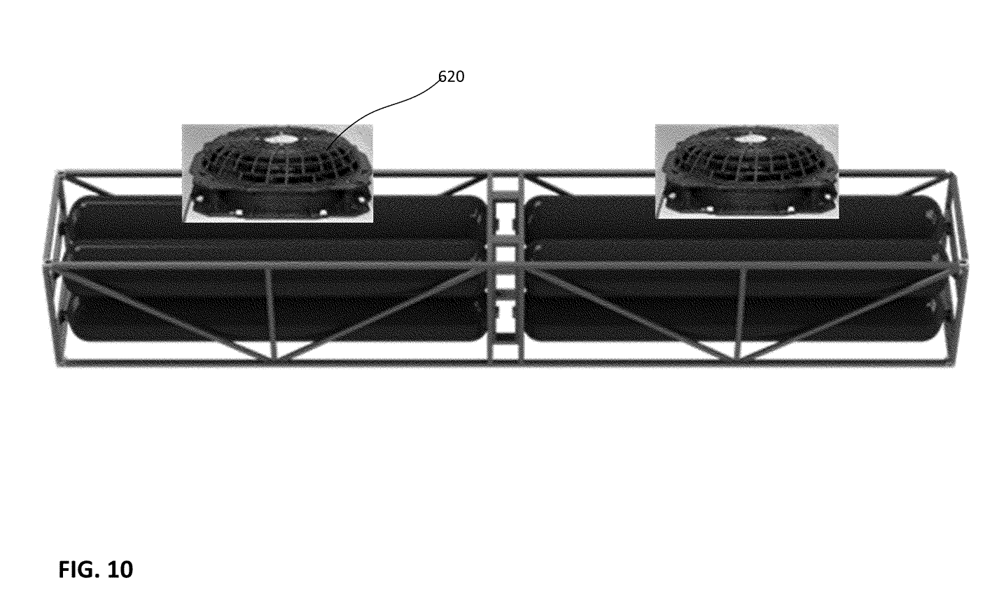

As shown in FIG. 10, the pressure vessel system may be kept cool using solar powered, explosion proof fans 620 and side vents. Air circulation from the cooling fans will allow improved heat transfer during fast filling of the vessels so that the internal temperature of the gas will be kept low, resulting higher gas densities and improved fill.

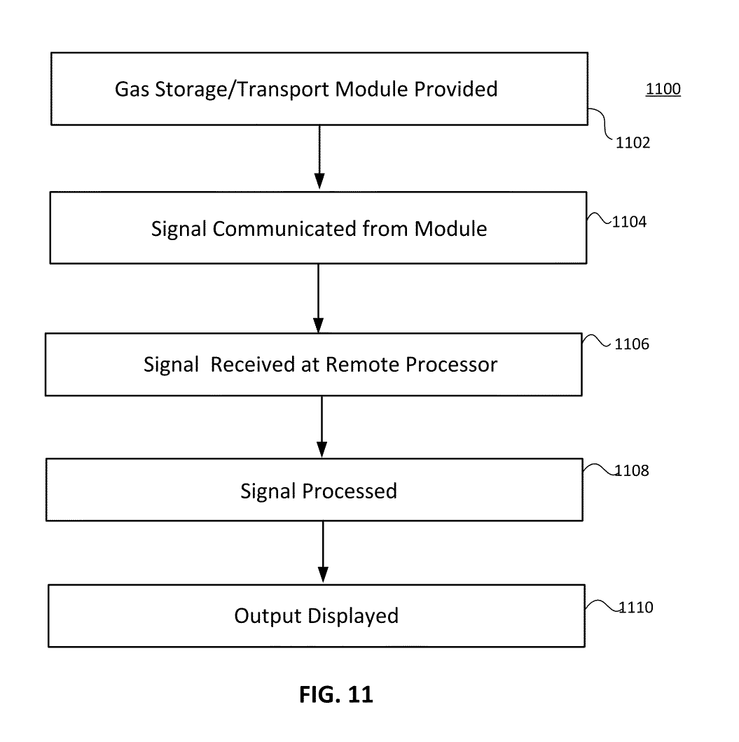

FIG. 11 is a simplified flow diagram illustrating a method 1100 according to an embodiment. In a first step 1102, a module is provided comprising a gas pressure storage vessel, and a sensor in communication therewith.

In a second step 1104, a signal from the sensor is communicated by the module. In a third step 1106, the signal is received by a remote processor.

In a fourth step 1108, the remote processor processes the signal to produce an output indicating a condition of the module. In a fifth step 1110, the output is displayed to on a user interface.

The following clauses describe various embodiments.

1B. An apparatus comprising:

a container frame;
a gas storage pressure vessel having a first end supported by the container frame and having a second end configured to move axially to accommodate expansion and contraction of the gas storage pressure vessel;
an end connector for the first end, the end connector incorporating an electrically or pneumatically actuated shut off valve, a pressure sensor, a temperature sensor, and a pressure relief device;
a module sensor packaged in a manifold housed at a rigid safety cage at a center of the container frame;
a wireless transceiver in communication with the end connector and the module sensor to transmit data relevant to the module; and
an electrical energy source configured to supply power to the end connector, the module sensor; and the wireless transceiver.

2B. An apparatus as in any of clauses 1B-9B wherein the electrical energy source comprises a battery.

3B. An apparatus as in any of clauses 2B-9B wherein the battery is charged by a solar photovoltaic charging system.

4B. An apparatus as in any of clauses 2B-9B wherein the battery is charged by other than a solar photovoltaic charging system.

5B. An apparatus as in any of clauses 1B-9B wherein the first end is encased in a C-channel.

6B. An apparatus as in any of clauses 1B-9B wherein the module sensor comprises a Global Positioning System (GPS) device.

7B. An apparatus as in any of clauses 1B-9B wherein the module sensor comprises an accelerometer.

8B. An apparatus as in any of clauses 1B-9B wherein the module further comprises a side vent.

9B. An apparatus as in any of clauses 1B-9B wherein the module further comprises a cooling fan operated by the electrical energy source.

10B. A method comprising:

a processor receiving a first wireless signal from a module sensor of a module comprising a plurality of gas storage pressure vessels within a container frame;
the processor receiving a second wireless signal from a tank sensor in communication with one of the plurality of gas storage pressure vessels; and
the processor processing the first wireless signal and the second wireless signal to produce an output indicating a module condition.

11B. A method as in any of clauses 10B-20B further comprising supplying power to the module sensor and to the tank sensor from a photovoltaic charging sensor of the module.

12B. A method as in any of clauses 10B-20B wherein the module sensor comprises a GPS device, and the output indicates a physical location of the module.

13B. A method as in any of clauses 10B-20B wherein the module sensor comprises an accelerometer, and the output indicates an impact event.

14B. A method as in clause 13B further comprising the output triggering a warning message.

15B. A method as in any of clauses 10B-20B wherein the module sensor comprises a pressure sensor, and the output indicates exceeding a maximum pressure.

16B. A method as in any of clauses 10B-20B wherein the module sensor comprises a pressure sensor, and the output indicates a mass of stored gas.

17B. A method as in any of clauses 10B-20B further wherein the module sensor comprises a temperature sensor.

18B. A method as in any of clauses 10B-20B further comprising displaying the output on a user interface.

19B. A method as in any of clauses 10B-20B wherein the output indicates a cumulative number of fill cycles.

20B. A method as in clause 19B further comprising the output triggering a warning message if a cycle count exceeds an end of life date or a requalification interval.

21B. A method comprising:

a transceiver transmitting a first wireless signal from a first sensor in communication with a compressed gas storage module; and
the transceiver transmitting a second wireless signal from a second sensor in communication with one of a plurality of compressed gas pressure vessels of the compressed gas storage module.

22B. A method as in any of clauses 21B-24B wherein the first sensor comprises a GPS sensor or an accelerometer.

23B. A method as in any of clauses 21B-24B wherein the second sensor comprises a temperature sensor or a pressure sensor.

24B. A method as in any of clauses 21B-24B further comprising the transceiver receiving power from a battery of the compressed gas storage module.

An issue associated with storing compressed gas (particularly at high densities) may be an amount of heat generated during a tank filling process. That is, the temperature within the storage vessel can increase substantially as large volumes of compressed gas are pumped in, and pressure increases within the confined space. Such increases in temperature can lead to a host of issues, including but not limited to thermal losses, ignition of the gaseous material, lower density of gas fill, and/or deterioration in the structural integrity of the tank.

Temperature changes associated with a tank filling process may be maintained within an acceptable range, by reducing a rate at which gaseous material is introduced into the tank. However, the time delay incurred by such an approach can have a significant impact upon cost, as personnel and equipment (such as ships and motor vehicles) remain idle during the period of tank filling.

Thus according to embodiments, thermal energy during a tank filling process, may be managed according to one or more techniques.

In certain embodiments, a phase change material may be used to absorb heat during filling of a tank with gaseous material. Conversion of phase change material from one state to another absorbs the heat arising during filling, allowing the process to proceed at an advanced rate. Upon removing gas from the tank, the phase change material converts back to its original state, surrendering heat to counteract cooling of the tank by gas expanding therein.

In certain embodiments, the phase change material may comprise a liquid that undergoes a change between the liquid and the gas state. Provided at the end of this document is a list of refrigerant materials that can undergo a transition between liquid and gas phase. Various of the materials listed may be suitable for use as phase change in accordance with particular embodiments.

The list at the end of this document is not exclusive. Other materials may be used for phase change according to embodiments. For example, in certain approaches phase change materials may be formed by azeotropes.

In some embodiments, the phase change material may comprise a solid that undergoes a change between the solid and the liquid state. Incorporated by reference herein for all purposes, is the following document to Janz et al.: “Physical Properties Data Compilations Relevant to Energy Storage, I. Molten Salts, Eutectic Data”, U.S. Department of Commerce (March 1978). This document lists a number of salts having specific melting points and which may be suitable as phase change materials in various embodiments.

Materials other than molten salts may be suitable phase change materials according to embodiments. Examples of such phase change materials may comprise hydrocarbon chains in solid form (e.g. as a wax), where the length of the hydrocarbon chain determines a specific melting point characteristic.

The phase change material can be selected according to one or more factors comprising physical characteristics. Examples of such physical characteristics can include but are not limited to melting point, boiling point, heat capacity, flammability, reactivity with the stored gas, and reactivity with the tank, over pressure, density, and/or temperature ranges expected to be encountered during the tank filling process.

Other factors may be considered in selecting a suitable phase change material. One such factor is its cost and/or availability. Another factor is its toxicity and/or environmental impact.

Still other factors that may influence selection of a phase change material, may relate to the ease and/or desirability of separating the phase change material from the stored gaseous material. Such factors may be relevant in determining whether the phase change material may be effectively removed for its later reuse. Such factors may also be relevant to determining whether introduction of the phase change material can degrade (or even potentially enhance—see CNG of the Example below) suitability of the stored gaseous material for its ultimate purpose or use, e.g., as a fuel or energy storage medium.

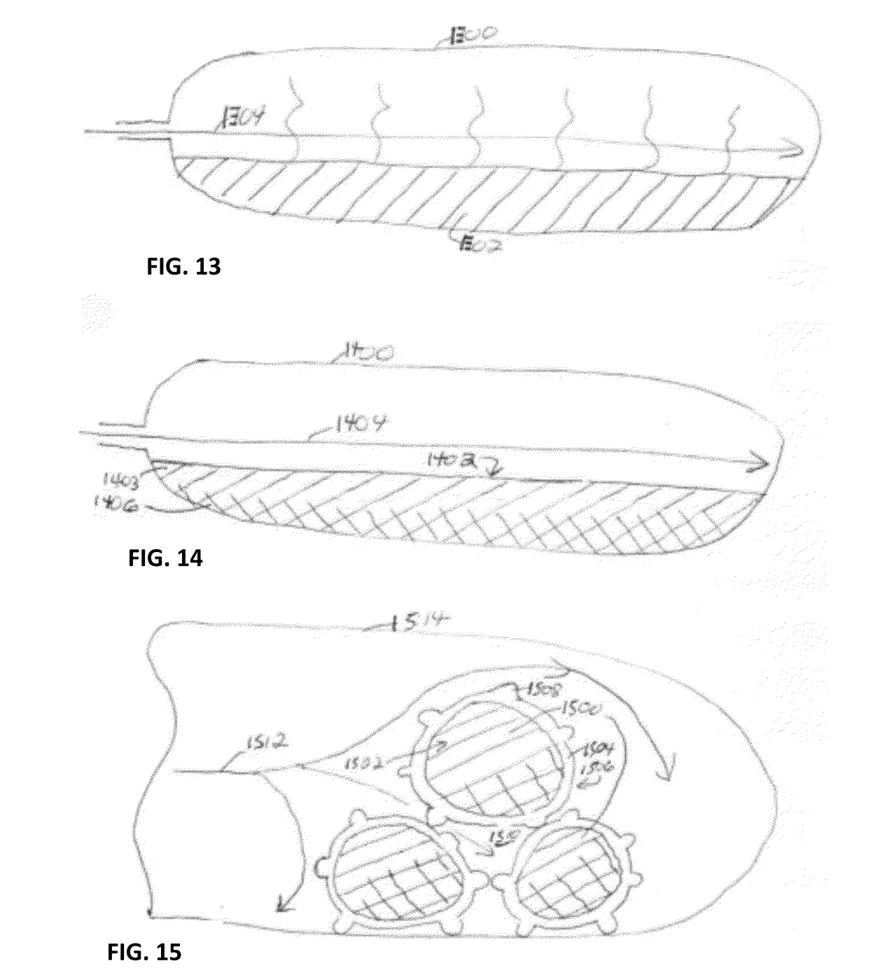

FIG. 13 shows a view of one simple embodiment. Here, tank 1300 contains a phase change material 1302 in the liquid state. As a gas 1304 is introduced to the tank for storage, the phase change material absorbs heat, converting in part or in whole to the gas state.

FIG. 14 shows a view of another simple embodiment. Here, tank 1400 contains a phase change material 1402 in the solid state 1403. As gas 1404 is introduced to the tank for storage, the phase change material heats up and converts in part or in whole to the liquid state 1406.

In certain embodiments, the phase change material in the liquid state could remain within the tank after filling. In other embodiments, however, at least some of the phase change material in the liquid state could be removed from the tank after filling (for example through a drain).

Such approaches removing phase change material subsequent to filling, could provide additional available space in the tank. Such additional space could receive more gas, or alternatively could allow for some expansion of the gas in the tank, lowering its temperature below prescribed limits.

It is further noted that removing phase change material subsequent to filling, could reduce weight of the filled tank. This consideration may be relevant to transport considerations, where weight limits imposed for roadways and rail beds can constrain an amount of gas that can be shipped.

In both of the simplified views of FIGS. 13-14, the phase change material sits at the bottom of the tank. The limited available surface area of the liquid or solid in such a configuration, may in turn limit a quality of thermal interaction occurring between the phase change material and the gas.

Accordingly, FIG. 15 shows a view of another embodiment, in which the phase change material 1500 is located within a space 1502 defined by walls 1504 of a hollow body 1506. (The relative size of the hollow bodies in FIG. 15 is grossly exaggerated for purposes of illustration).

The walls 1504 define projections 1508 creating a stand-off between the hollow body and adjacent hollow bodies. This stand-off affords space 1510 for gas 1512 incoming to the tank 1514 for storage, to penetrate.

The incoming gas may then exchange heat through the walls with the phase change material inside (shown here as solid converting to liquid, but alternatively liquid converting to gas). In this manner, the effective surface area of the phase change material is increased, promoting more extensive thermal interaction and facilitating a rapid tank filling process.

In embodiments as in FIG. 15, material comprising walls of the hollow body may be selected for certain properties. Examples of such properties can include but are not limited to flexibility, durability, and non-corrosion.

In particular, flexibility may be desirable as the volume occupied by the phase change material may change as it experiences a change in state (e.g., conversion from solid to liquid and/or from liquid to gas, and then back again). A wall made of flexible material may adjust in shape to accommodate this changing volume. One example of such a flexible material could be a plastic having a melting point higher than any temperatures expected to be encountered during the tank filling process.

Shapes and/or sizes of the hollow bodies containing the phase change material, may differ according to embodiments. One consideration for the shape of the hollow bodies may be to maximize available surface area for heat transfer to the phase change material, while maximizing the space available in the tank to receive the gas. Another consideration relating to hollow body shape may be cost/ease of fabrication.

In certain embodiments the phase change material may be introduced into the hollow bodies once they are formed. In some embodiments the hollow body may be formed around the phase change material, for example by a thermoset, molding, curing, or other fabrication process.

A consideration for the size of the hollow bodies may relate to the ability to remove them from the tank (e.g., for transport, recharging, or even swapping out for a different phase change material). Thus in certain embodiments, the hollow bodies may be sufficiently small to pass through an opening in the tank boss prior to manifold attachment, but sufficiently large not to pass through the opening in the tank once the manifold is attached to the tank boss.

Certain embodiments could position the phase change material within a member that is insertable into the tank during filling, but which may then be subsequently removed (e.g., prior to tank transport). A particular embodiment could comprise a member that is first inserted into the tank in collapsed form, then expands to provide additional surface area during filling, and is later collapsed for removal.

One particular embodiment could comprise a coil receiving phase change material. Such a coil could expand to unwind by twisting, and then collapse by twisting in an opposite direction.

As described above, it is useful to increase to available surface area between the phase change material and the gas (e.g., through the use of hollow bodies). The heat exchange process may also be enhanced by causing gas within the tank to circulate. This might be accomplished with a fan, blower, or stirrer placed within the tank.

In certain embodiments, external connections to the tank could be used to draw gas through a blower and reintroduce the gas into the tank, aiding circulation within the tank. In some embodiments, the fan could be temporarily inserted into the tank only during filling and discharge, and removed for transport.

### Example

Compressed natural gas (CNG) represents a promising fuel source given its clean burning properties and relative abundance. CNG is typically present as a mixture of components (primarily methane and ethane).

Propane is a hydrocarbon that is also used as a fuel. At pressures typical of storage and transport of CNG in the gas state, propane remains in the liquid state. Over the course of temperature increases typical of CNG tank filling, however, propane experiences a phase change to a gas. Moreover, propane exhibits a heat capacity that renders it suitable for absorbing quantities of heat that may result from tank filling. Thus, according to an embodiment, liquid propane may be utilized as a phase change material to absorb heat generated in the filling of tanks with CNG.

Propane may be particularly suited for use in CNG tank filling applications for at least two additional reasons. One reason is that propane itself is a fuel, and hence does not need to be separated from the CNG once introduced. That is, the propane can remain in the CNG and be removed from the tank (reducing weight) and consumed at with the CNG. Under the conditions expected in the CNG tank, propane may be mostly liquid, with only a small portion gaseous due to its low vapor pressure. The tank may be emptied of CNG plus this small amount of gaseous propane, while the liquid propane remains in the bottom of the tank. This liquid propane may be removed separately if desired, or it may remain in expectation of refilling the tank.

Another reason potentially favoring use of propane in CNG tank filling applications, is its availability. That is, propane as a product of natural gas harvesting may be readily available at the same time and place as the CNG that is to be flowed into the tank.

While this particular example cites propane as a phase change material for use in CNG tank filling, other materials may be suited for this purpose. One possible instance of an alternative such phase change material, is butane.

Other techniques may be employed separately or in conjunction with a phase change, in order to manage thermal energy during tank filling. For example, in certain embodiments a heat of tank filling may be absorbed by the tank itself. The outside walls of the tank may in turn be in communication with a heat exchange medium (which may be a phase change material) in order to dissipate or even store the heat. One simple example is positioning a tank within a bath of a phase change material, such that heat of filling is communicated to the bath.

In certain embodiments, the structure of the tank may be designed to facilitate the desired absorption and communication of heat flows. For example, one type of tank may comprise a liner wrapped with a filament. In certain embodiments, the liner may comprise a material having favorable thermal conductivity properties, for example a metal such as aluminum.

Such a metal liner, however, contributes to the tank weight, essentially detracting from the weight available for gas storage and/or tank design (or even for phase change material, if present). In order to reduce the weight consumed by a tank liner and thus free additional weight for use, particular embodiments may involve a filling process utilizing multiple tanks.

That is, the gas may be initially flowed into a smaller tank having a metal liner conducive to heat absorption and transfer. From this first, smaller tank the gas may then be flowed into a second, larger tank having a liner made out of a different, lighter material (e.g., plastic) but exhibiting less efficient thermal conduction properties.

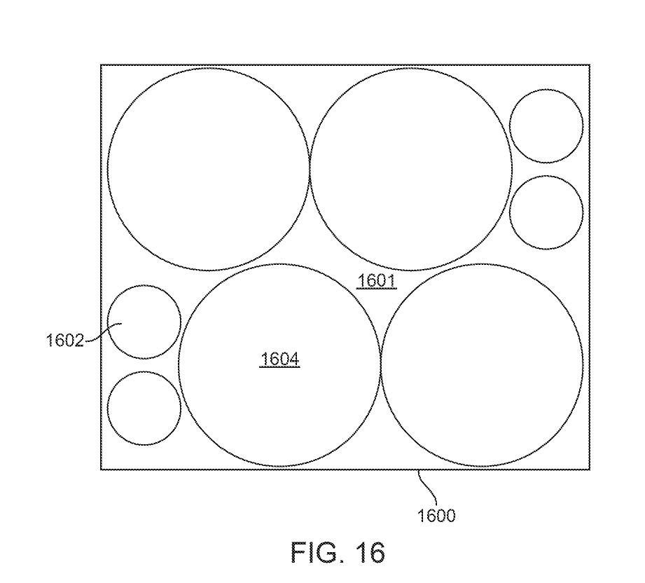

An approach as has just been described, may be beneficial in that that the use of multiple tanks of different sizes for storage, may be favored by other considerations. For example, FIG. 16 shows a simplified cross-sectional view of a standard-sized shipping container 1600 configured to hold tanks having a circular cross-section. (For purposes of illustration, connections permitting flow to occur between the various tanks are omitted from the view of FIG. 16).

In such an embodiment, the most space efficient manner of occupying the available cross-sectional space 1601 (here square) of the shipping container, may be to utilize tanks having different diameters. As shown, tanks having a first (smaller) size 1602 including a heat conducting metal liner, may be arranged together with tanks having a second (larger) size 1604 including a liner made from a lighter-weight material. Such a configuration may combine light weight with efficient management of thermal energy.

While the above discussion has focused upon the thermal conductivity properties of a liner material, other tank components may play a role in thermal management. For example, as mentioned above some tanks may employ a composite design having a liner wrapped with a filament.

According to certain embodiments, this filament may comprise a material that is conducive to flowing heat. One example of such a filament material may be carbon.

A variety of shapes (e.g., fibers, flakes, powders, microspheres, others) may be employed, in a variety of sizes (nano, micro, etc.) Carbon nanotubes, flake graphite, pitch cake, and needle cake could be used. Moreover, carbon composites can incorporate additives such as boron nitride or aluminum nitride (in amounts up to 15%, up to 10%, or up to 5%, for example), that may be useful in controlling thermal properties while maintaining a sufficient strength of the composite.

The following represents a non-exclusive list of substances that could serve as phase change materials. Here, ASHRAE refers to the American Society of Heating, Refrigerating, and Air-Conditioning Engineers.

(ASHRAE No./Name/Formula/CAS No.; where available):

### R-600/Butane/CH3CH2CH2CH3/106-97-8;

R-600a/Isobutane/CH(CH3)2CH3/75-28-5;

### R-601/Pentane/CH3CH2CH2CH2CH3/109-66-0;

R-601a/Isopentane/(CH3)2CHCH2CH3/78-78-4;
R-610/Diethyl ether/C2HSOC2H5/60-29-7;
R-611/Methyl formate/C2H40/107-31-3;

### R-630/Methylamine/CH2NH2/74-89-5;

### R-631/Ethylamine/C2H5NH2/75-04-7;

### R-702/Hydrogen/H2/1333-74-0;

### R-704/Helium/He/7440-59-7;

### R-717/Ammonia/NH3/7664-41-7;

### R-718/Water/H2O/7732-18-5;

### R-720/Neon/Ne/7440-01-9;

### R-728/Nitrogen/N2/7727-37-9;

### R-732/Oxygen/O2/7782-44-7;

### R-740/Argon/Ar/7440-37-1;

R-744/Carbon dioxide/CO2/124-38-9;
R-744A/Nitrous oxide/N2O/10024-97-2;
R-764/Sulfur dioxide/SO2/7446-09-5;

### R-784/Krypton/Kr/7439-90-9;

R-1112a/1,1-Dichloro-2,2-difluoroethylene/C2Cl2F2/79-35-6;

### R-1113/Chlorotrifluoroethylene/C2ClF3/79-38-9;

### R-1114/Tetrafluoroethylene/C2F4/116-14-3;

### R-1120/Trichloroethylene/C2HCl3/79-01-6;

R-1130/cis-1,2-Dichloroethylene/C2H2Cl2/156-59-2;

### R-1132/1,1-Difluoroethylene/C2H2F2/75-38-7;

R-1140/Chloroethylene/C2H3Cl/75-01-4;

### R-1141/Fluoroethylene/C2H3F/75-02-5;

### R-1150/Ethylene/C2H4/74-85-1;

### R-1216/Hexafluoropropylene/C3F6/116-15-4;

NA/Hexafluoropropene trimer/(C3F6)3/6792-31-0;

### R-1270/Propylene/C3H6/115-07-1;

### R-10/Tetrachloromethane/CCl4/56-23-5;

### R-11/Trichlorofluoromethane/CCl3F/75-69-4;

### R-12/Dichlorodifluoromethane/CCl2F2/75-71-8;

### R-12B1/Bromochlorodifluoromethane/CBrClF2/353-59-3;

### R-12B2/Dibromodifluoromethane/CBr2F2/75-61-6;

### R-13/Chlorotrifluoromethane/CClF3/75-72-9;

### R-13B1/Bromotrifluoromethane/CF3Br/75-63-8

### R-14/Tetrafluoromethane/CF4/75-73-0;

### R-20 Trichloromethane CHCl3 67-66-3;

### R-21/Dichlorofluoromethane/CHFCl2/75-43-4;

### R-22/Chlorodifluoromethane/CHClF2/75-45-6;

### R-22B1/Bromodifluoromethane/CHBrF2/1511-62-2;

### R-23/Trifluoromethane/CHF3/75-46-7;

### R-30/Dichloromethane/CH2Cl2/75-09-2;

### R-31 Chlorofluoromethane CH2FCl593-70-4;

### R-32/Difluoromethane/CH2F2/75-10-5;

### R-40/Chloromethane/CH3Cl/74-87-3;

### R-41/Fluoromethane/CH3F/593-53-3;

### R-50/Methane/CH4/74-82-8;

### R-110/Hexachloroethane/C2Cl6/67-72-1;

### R-111/Pentachlorofluoroethane/C2FCl5/354-56-3

R-112/1,1,2,2-Tetrachloro-1,2-difluoroethane/C2F2Cl4/76-12-0;
R-112a/1,1,1,2-Tetrachloro-2,2-difluoroethane/C2F2Cl4/76-11-9;

### R-113/1,1,2-Trichlorotrifluoroethane/C2F3Cl3/76-13-1;

R-113a/1,1,1-Trichlorotrifluoroethane/C2F3Cl3/354-58-5;

### R-114/1,2-Dichlorotetrafluoroethane/C2F4Cl2/76-14-2;

R-114a/1,1-Dichlorotetrafluoroethane/C2F4Cl2/374-07-2;

### R-114B2/Dibromotetrafluoroethane/C2F4Br2/124-73-2;

### R-115/Chloropentafluoroethane/C2F5Cl/76-15-3;

### R-116/Hexafluoroethane/C2F6/76-16-4;

### R-120/Pentachloroethane/C2HCl5/76-01-7;

R-121/1,1,2,2-Tetrachloro-1-fluoroethane/C2HFCl4/354-14-3;
R-121a/1,1,1,2-Tetrachloro-2-fluoroethane/C2HFCl4/354-11-0;
R-122/1,1,2-Trichloro-2,2-difluoroethane/C2HF2Cl3/354-21-2;
R-122a/1,1,2-Trichloro-1,2-difluoroethane/C2HF2Cl3/354-15-4;
R-122b/1,1,1-Trichloro-2,2-difluoroethane/C2HF2Cl3/354-12-1;
R-123/2,2-Dichloro-1,1,1-trifluoroethane/C2HF3Cl2/306-83-2;
R-123a/1,2-Dichloro-1,1,2-trifluoroethane/C2HF3Cl2/354-23-4;
R-123b/1,1-Dichloro-1,2,2-trifluoroethane/C2HF3Cl2/812-04-4;
R-124/2-Chloro-1,1,1,2-tetrafluoroethane/C2HF4Cl/2837-89-0;
R-124a/1-Chloro-1,1,2,2-tetrafluoroethane/C2HF4Cl/354-25-6;

### R-125/Pentafluoroethane/C2HF5/354-33-6;

### R-E125/(Difluoromethoxy)(trifluoro)methane/C2HF5O/3822-68-2;

### R-130/1,1,2,2-Tetrachloroethane/C2H2Cl4/79-34-5;

R-130a/1,1,1,2-Tetrachloroethane/C2H2Cl4/630-20-6;
R-131/1,1,2-trichloro-2-fluoroethane/C2H2FCl3/359-28-4;
R-131a/1,1,2-trichloro-1-fluoroethane/C2H2FCl3/811-95-0;
R-131b/1,1,1-trichloro-2-fluoroethane/C2H2FCl3/2366-36-1;

### R-132/Dichlorodifluoroethane/C2H2F2Cl2/25915-78-0;

R-132a/1,1-Dichloro-2,2-difluoroethane/C2H2F2Cl2/471-43-2;
R-132b/1,2-Dichloro-1,1-difluoroethane/C2H2F2Cl2/1649-08-7;
R-132c/1,1-Dichloro-1,2-difluoroethane/C2H2F2Cl2/1842-05-3;
R-132b/1,2/1,2-Dibromo-1,1-difluoroethane/C2H2Br2F2/75-82-1;

### R-133/1-Chloro-1,2,2-Trifluoroethane/C2H2F3O/431-07-2;

R-133a/1-Chloro-2,2,2-Trifluoroethane/C2H2F3Cl/75-88-7;
R-133b/1-Chloro-1,1,2-Trifluoroethane/C2H2F3Cl/421-04-5;

### R-134/1,1,2,2-Tetrafluoroethane/C2H2F4/359-35-3;

R-134a/1,1,1,2-Tetrafluoroethane/C2H2F4/811-97-2;

### R-E134/Bis(difluoromethyl)ether/C2H2F4O/1691-17-4;

### R-140/1,1,2-Trichloroethane/C2H3Cl3/79-00-5;

R-140a/1,1,1-Trichloroethane/C2H3Cl3/71-55-6;
R-141/1,2-Dichloro-1-fluoroethane/C2H3FCl2/430-57-9;
R-141B2/1,2-Dibromo-1-fluoroethane/C2H3Br2F/358-97-4;
R-141a/1,1-Dichloro-2-fluoroethane/C2H3FCl2/430-53-5;
R-141b/1,1-Dichloro-1-fluoroethane/C2H3FCl2/1717-00-6;

### R-142/Chlorodifluoroethane/C2H3F2Cl/25497-29-4;

R-142a/1-Chloro-1,2-difluoroethane/C2H3F2Cl/25497-29-4;
R-142b/1-Chloro-1,1-difluoroethane/C2H3F2Cl/75-68-3;

### R-143/1,1,2-Trifluoroethane/C2H3F3/430-66-0 300;

R-143a/1,1,1-Trifluoroethane/C2H3F3/420-46-2 3,800;
R-143m/Methyl trifluoromethyl ether/C2H3F3O/421-14-7;
R-E143a/2,2,2-Trifluoroethyl methyl ether/C3H5F3O/460-43-5;

### R-150/1,2-Dichloroethane/C2H4Cl2/107-06-2;

R-150a/1,1-Dichloroethane/C2H4Cl2/75-34-3;

### R-151/Chlorofluoroethane/C2H4ClF/110587-14-9;

R-151a/1-Chloro-1-fluoroethane/C2H4ClF/1615-75-4;

### R-152/1,2-Difluoroethane/C2H4F2/624-72-6;

R-152a/1,1-Difluoroethane/C2H4F2/75-37-6;

### R-160/Chloroethane/C2H5Cl/75-00-3;

### R-161/Fluoroethane/C2H5F/353-36-6;

### R-170/Ethane/C2H6/74-84-0;

R-211/1,1,1,2,2,3,3-Heptachloro-3-fluoropropane/C3FCl7/422-78-6;

### R-212/Hexachlorodifluoropropane/C3F2Cl6/76546-99-3;

R-213/1,1,1,3,3-Pentachloro-2,2,3-trifluoropropane/C3F3Cl5/2354-06-5;
R-214/1,2,2,3-Tetrachloro-1,1,3,3-tetrafluoropropane/C3F4Cl4/2268-46-4;
R-215/1,1,1-Trichloro-2,2,3,3,3-pentafluoropropane/C3F5Cl3/4259-43-2;
R-216/1,2-Dichloro-1,1,2,3,3,3-hexafluoropropane/C3F6Cl2/661-97-2;
R-216ca/1,3-Dichloro-1,1,2,2,3,3-hexafluoropropane/C3F6Cl2/662-01-1;
R-217/1-Chloro-1,1,2,2,3,3,3-heptafluoropropane/C3F7Cl/422-86-6;
R-217ba/2-Chloro-1,1,1,2,3,3,3-heptafluoropropane/C3F7Cl/76-18-6;

### R-218/Octafluoropropane/C3F8/76-19-7;

R-221/1,1,1,2,2,3-Hexachloro-3-fluoropropane/C3HFCl6/422-26-4;

### R-222/Pentachlorodifluoropropane/C3HF2Cl5/134237-36-8;

R-222c/1,1,1,3,3-Pentachloro-2,2-difluoropropane/C3HF2Cl5/422-49-1;

### R-223/Tetrachlorotrifluoropropane/C3HF3Cl4/134237-37-9;

R-223ca/1,1,3,3-Tetrachloro-1,2,2-trifluoropropane/C3HF3Cl4/422-52-6;
R-223cb/1,1,1,3-Tetrachloro-2,2,3-trifluoropropane/C3HF3Cl4/422-50-4;

### R-224/Trichlorotetrafluoropropane/C3HF4Cl3/134237-38-0;

R-224ca/1,3,3-Trichloro-1,1,2,2-tetrafluoropropane/C3HF4Cl3/422-54-8;
R-224cb/1,1,3-Trichloro-1,2,2,3-tetrafluoropropane/C3HF4Cl3/422-53-7;
R-224cc/1,1,1-Trichloro-2,2,3,3-tetrafluoropropane/C3HF4Cl3/422-51-5;

### R-225/Dichloropentafluoropropane/C3HF5Cl2/127564-92-5;

R-225aa/2,2-Dichloro-1,1,1,3,3-pentafluoropropane/C3HF5Cl2/128903-21-9;
R-225ba/2,3-Dichloro-1,1,1,2,3-pentafluoropropane/C3HF5Cl2/422-48-0;
R-225bb/1,2-Dichloro-1,1,2,3,3-pentafluoropropane/C3HF5Cl2/422-44-6;
R-225ca/3,3-Dichloro-1,1,1,2,2-pentafluoropropane/C3HF5Cl2/422-56-0;
R-225cb/1,3-Dichloro-1,1,2,2,3-pentafluoropropane/C3HF5Cl2/507-55-1;
R-225cc/1,1-Dichloro-1,2,2,3,3-pentafluoropropane/C3HF5Cl2/13474-88-9;
R-225da/1,2-Dichloro-1,1,3,3,3-pentafluoropropane/C3HF5Cl2/431-86-7;
R-225ea/1,3-Dichloro-1,1,2,3,3-pentafluoropropane/C3HF5Cl2/136013-79-1;
R-225eb/1,1-Dichloro-1,2,3,3,3-pentafluoropropane/C3HF5Cl2/111512-56-2;

### R-226/Chlorohexafluoropropane/C3HF6Cl/134308-72-8;

R-226ba/2-Chloro-1,1,1,2,3,3-hexafluoropropane/C3HF6Cl/51346-64-6;
R-226ca/3-Chloro-1,1,1,2,2,3-hexafluoropropane/C3HF6Cl/422-57-1;
R-226cb/1-Chloro-1,1,2,2,3,3-hexafluoropropane/C3HF6Cl/422-55-9;
R-226da/2-Chloro-1,1,1,3,3,3-hexafluoropropane/C3HF6Cl/431-87-8;
R-226ea/1-Chloro-1,1,2,3,3,3-hexafluoropropane/C3HF6Cl/359-58-0;
R-227ca/1,1,2,2,3,3,3-Heptafluoropropane/C3HF7/2252-84-8;
R-227ca2/Trifluoromethyl 1,1,2,2-tetrafluoroethyl ether/C3HF7O/2356-61-8;
R-227ea/1,1,1,2,3,3,3-Heptafluoropropane/C3HF7/431-89-0;
R-227me/Trifluoromethyl 1,2,2,2-tetrafluoroethyl ether/C3HF7O/2356-62-9;

### R-231/Pentachlorofluoropropane/C3H2FCl5/134190-48-0;

### R-232/Tetrachlorodifluoropropane/C3H2F2Cl4/134237-39-1;

R-232ca/1,1,3,3-Tetrachloro-2,2-difluoropropane/C3H2F2Cl4/1112-14-7;
R-232cb/1,1,1,3-Tetrachloro-2,2-difluoropropane/C3H2F2Cl4/677-54-3;

### R-233/Trichlorotrifluoropropane/C3H2F3Cl3/134237-40-4;

R-233ca/1,1,3-Trichloro-2,2,3-trifluoropropane/C3H2F3 Cl3/131221-36-8;
R-233cb/1,1,3-Trichloro-1,2,2-trifluoropropane/C3H2F3Cl3/421-99-8;
R-233cc/1,1,1-Trichloro-2,2,3-trifluoropropane/C3H2F3Cl3/131211-71-7;

### R-234/Dichlorotetrafluoropropane/C3H2F4Cl2/127564-83-4;

R-234aa/2,2-Dichloro-1,1,3,3-tetrafluoropropane/C3H2F4Cl2/17705-30-5;
R-234ab/2,2-Dichloro-1,1,1,3-tetrafluoropropane/C3H2F4Cl2/149329-24-8;
R-234ba/1,2-Dichloro-1,2,3,3-tetrafluoropropane/C3H2F4Cl2/425-94-5;
R-234bb/2,3-Dichloro-1,1,1,2-tetrafluoropropane/C3H2F4Cl2/149329-25-9;
R-234bc/1,2-Dichloro-1,1,2,3-tetrafluoropropane/C3H2F4Cl2/149329-26-0;
R-234ca/1,3-Dichloro-1,2,2,3-tetrafluoropropane/C3H2F4Cl2/70341-81-0;
R-234cb/1,1-Dichloro-2,2,3,3-tetrafluoropropane/C3H2F4Cl2/4071-01-6;
R-234cc/1,3-Dichloro-1,1,2,2-tetrafluoropropane/C3H2F4Cl2/422-00-5;
R-234cd/1,1-Dichloro-1,2,2,3-tetrafluoropropane/C3H2F4Cl2/70192-63-1;
R-234da/2,3-Dichloro-1,1,1,3-tetrafluoropropane/C3H2F4Cl2/146916-90-7;
R-234fa/1,3-Dichloro-1,1,3,3-tetrafluoropropane/C3H2F4Cl2/76140-39-1;
R-234fb/1,1-Dichloro-1,3,3,3-tetrafluoropropane/C3H2F4Cl2/64712-27-2;

### R-235/Chloropentafluoropropane/C3H2F5Cl/134237-41-5;

R-235ca/1-Chloro-1,2,2,3,3-pentafluoropropane/C3H2F5Cl/28103-66-4;
R-235cb/3-Chloro-1,1,1,2,3-pentafluoropropane/C3H2F5Cl/422-02-6;
R-235cc/1-Chloro-1,1,2,2,3-pentafluoropropane/C3H2F5Cl/679-99-2;
R-235da/2-Chloro-1,1,1,3,3-pentafluoropropane/C3H2F5Cl/134251-06-2;
R-235fa/1-Chloro-1,1,3,3,3-pentafluoropropane/C3H2F5Cl/677-55-4;
R-236cb/1,1,1,2,2,3-Hexafluoropropane/C3H2F6/677-56-5;
R-236ea/1,1,1,2,3,3-Hexafluoropropane/C3H2F6/431-63-0;
R-236fa/1,1,1,3,3,3-Hexafluoropropane/C3H2F6/690-39-1;
R-236me/1,2,2,2-Tetrafluoroethyl difluoromethyl ether/C3H2F6O/57041-67-5;

### R-FE-36/Hexafluoropropane/C3H2F6/359-58-0;

### R-241/Tetrachlorofluoropropane/C3H3FCl4/134190-49-1;

### R-242/Trichlorodifluoropropane/C3H3F2Cl3/134237-42-6;

### R-243/Dichlorotrifluoropropane/C3H3F3Cl2/134237-43-7;

R-243ca/1,3-Dichloro-1,2,2-trifluoropropane/C3H3F3Cl2/67406-68-2;
R-243cb/1,1-Dichloro-2,2,3-trifluoropropane/C3H3F3Cl2/70192-70-0;
R-243cc/1,1-Dichloro-1,2,2-trifluoropropane/C3H3F3Cl2/7125-99-7;
R-243da/2,3-Dichloro-1,1,1-trifluoropropane/C3H3F3Cl2/338-75-0;
R-243ea/1,3-Dichloro-1,2,3-trifluoropropane/C3H3F3Cl2/151771-08-3;
R-243ec/1,3-Dichloro-1,1,2-trifluoropropane/C3H3F3Cl2/149329-27-1;

### R-244/Chlorotetrafluoropropane/C3H3F4Cl/134190-50-4;

R-244ba/2-Chloro-1,2,3,3-tetrafluoropropane/C3H3F4Cl;
R-244bb/2-Chloro-1,1,1,2-tetrafluoropropane/C3H3F4Cl/421-73-8;
R-244ca/3-Chloro-1,1,2,2-tetrafluoropropane/C3H3F4Cl/679-85-6;
R-244cb/1-Chloro-1,2,2,3-tetrafluoropropane/C3H3F4Cl/67406-66-0;
R-244cc/1-Chloro-1,1,2,2-tetrafluoropropane/C3H3F4Cl/421-75-0;
R-244da/2-Chloro-1,1,3,3-tetrafluoropropane/C3H3F4Cl/19041-02-2;
R-244db/2-Chloro-1,1,1,3-tetrafluoropropane/C3H3F4Cl/117970-90-8;
R-244ea/3-Chloro-1,1,2,3-tetrafluoropropane/C3H3F4Cl;
R-244eb/3-Chloro-1,1,1,2-tetrafluoropropane/C3H3F4Cl;
R-244ec/1-Chloro-1,1,2,3-tetrafluoropropane/C3H3F4Cl;
R-244fa/3-Chloro-1,1,1,3-tetrafluoropropane/C3H3F4Cl;
R-244fb/1-Chloro-1,1,3,3-tetrafluoropropane/C3H3F4Cl/2730-64-5;
R-245ca/1,1,2,2,3-Pentafluoropropane/C3H3F5/679-86-7560;
R-245cb/Pentafluoropropane/C3H3F5/1814-88-6;
R-245ea/1,1,2,3,3-Pentafluoropropane/C3H3F5/24270-66-4;
R-245eb/1,1,1,2,3-Pentafluoropropane/C3H3F5/431-31-2;
R-245fa/1,1,1,3,3-Pentafluoropropane/C3H3F5/460-73-1;
R-245mc/Methyl pentafluoroethyl ether/C3H3F5O/22410-44-2;
R-245mf/Difluoromethyl 2,2,2-trifluoroethyl ether/C3H3F5O/1885-48-9;
R-245qc/Difluoromethyl 1,1,2-trifluoroethyl ether/C3H3F5O/69948-24-9;

### R-251/Trichlorofluoropropane/C3H4FCl3/134190-51-5;

### R-252/Dichlorodifluoropropane/C3H4F2Cl2/134190-52-6;

R-252ca/1,3-Dichloro-2,2-difluoropropane/C3H4F2Cl2/1112-36-3;
R-252cb/1,1-Dichloro-2,2-difluoropropane/C3H4F2Cl2/1112-01-2;
R-252dc/1,2-Dichloro-1,1-difluoropropane/C3H4F2Cl2;
R-252ec/1,1-Dichloro-1,2-difluoropropane/C3H4F2Cl2;

### R-253/Chlorotrifluoropropane/C3H4F3Cl 134237-44-8;

R-253ba/2-Chloro-1,2,3-trifluoropropane/C3H4F3Cl;
R-253bb/2-Chloro-1,1,2-trifluoropropane/C3H4F3Cl;
R-253ca/1-Chloro-2,2,3-trifluoropropane/C3H4F3Cl/56758-54-4;
R-253cb/1-Chloro-1,2,2-trifluoropropane/C3H4F3Cl/70192-76-6;
R-253ea/3-Chloro-1,1,2-trifluoropropane/C3H4F3Cl;
R-253eb/1-Chloro-1,2,3-trifluoropropane/C3H4F3Cl;
R-253ec/1-Chloro-1,1,2-trifluoropropane/C3H4F3Cl;
R-253fa/3-Chloro-1,3,3-trifluoropropane/C3H4F3Cl;
R-253fb/3-Chloro-1,1,1-trifluoropropane/C3H4F3Cl/460-35-5;
R-253fc/1-Chloro-1,1,3-trifluoropropane/C3H4F3Cl;
R-254cb/1,1,2,2-Tetrafluoropropane/C3H4F4/40723-63-5;
R-254pc/Methyl 1,1,2,2-tetrafluoroethyl ether/C3H4F4O/425-88-7;

### R-261/Dichlorofluoropropane/C3H5FCl2/134237-45-9;

R-261ba/1,2-Dichloro-2-fluoropropane/C3H5FCl2/420-97-3;

### R-262/Chlorodifluoropropane/C3H5F2Cl/134190-53-7;

R-262ca/1-Chloro-2,2-difluoropropane/C3H5F2Cl/420-99-5;
R-262fa/3-Chloro-1,1-difluoropropane/C3H5F2Cl;
R-262fb/1-Chloro-1,3-difluoropropane/C3H5F2Cl;

### R-263/Trifluoropropane/C3H5F3;

### R-271/Chlorofluoropropane/C3H6FCl/134190-54-8;

R-271b/2-Chloro-2-fluoropropane/C3H6FCl/420-44-0;
R-271d/2-Chloro-1-fluoropropane/C3H6FCl;
R-271fb/1-Chloro-1-fluoropropane/C3H6FCl;

### R-272/Difluoropropane/C3H6F2;

### R-281/Fluoropropane/C3H7F;

### R-290/Propane/C3H8/74-98-6;

### R-C316/Dichlorohexafluorocyclobutane/C4Cl2F6/356-18-3;

### R-C317/Chloroheptafluorocyclobutane/C4ClF7/377-41-3;

### R-C318/Octafluorocyclobutane/C4F8/115-25-3;

### R-3-1-10/Decafluorobutane/C4F10;

R-329ccb/375-17-7;
R-338eea/75995-72-1;
R-347ccd/662-00-0;
R-347mcc/Perfluoropropyl methyl ether/C4H3F7O/375-03-1;
R-347mmy/Perfluoroisopropyl methyl ether/C4H3F7O/22052-84-2;
R-356mcf/
R-356mffm/
R-365 mfc/1,1,1,3,3-Pentafluorobutane/C4H5F5

### FC-72/Tetradecafluorohexane/C6F14 355-42-0

R-400 R-12/R-114 (60/40 wt %) binary blend
R-401A R-22/R-152a/R-124 (53/13/34)
R-401B R-22/R-152a/R-124 (61/11/28)
R-401C R-22/R-152a/R-124 (33/15/52)

### R-402A R-125/R-290/R-22 (60/2/38)

### R-402B R-125/R-290/R-22 (38/2/60)

### R-403A R-290/R-22/R-218 (5/75/20)

### R-403B R-290/R-22/R-218 (5/56/39)

R-404A R-125/R-143a/R-134a (44/52/4) R-405A R-22/R-152a/R-142b/R-C318 (45/7/5.5/42.5)
R-406A R-22/R-600a/R-142b (55/04/41)

### R-407A R-32/R-125/R-134a (20/40/40)

### R-407B R-32/R-125/R-134a (10/70/20)

### R-407C R-32/R-125/R-134a (23/25/52)

### R-407D R-32/R-125/R-134a (15/15/70)

### R-407E R-32/R-125/R-134a (25/15/60)

R-408A R-125/R-143a/R-22 (7/46/47)

### R-409A R-22/R-124/R-142b (60/25/15)

### R-409B R-22/R-124/R-142b (65/25/10)

### R-410A R-32/R-125 (50/50)

### R-410B R-32/R-125 (45/55)

### R-411A R-1270/R-22/R-152a (1.5/87.5/11)

### R-411B R-1270/R-22/R-152a (3/94/3)

### R-412A R-22/R-218/R-142b (70/5/25)

R-413A R-218/R-134a/R-600a (9/88/3)
R-414A R-22/R-124/R-600a/R-142b (51/28.5/4.0/16.5)
R-414B R-22/R-124/R-600a/R-142b (50/39/1.5/9.5)

### R-415A R-22/R-152a (82/18)

### R-415B R-22/R-152a (25/75)

R-416A R-134a/R-124/R-600 (59/39.5/1.5)
R-417A R-125/R-134a/R-600 (46.6/50.0/3.4)

### R-418A R-290/R-22/R-152a (1.5/96/2.5)

R-419A R-125/R-134a/R-E170 (77/19/4)
R-420A R-134a/R-142b (88/12)

### R-421A R-125/R-134a (58/42)

### R-421B R-125/R-134a (85/15)

R-422A R-125/R-134a/R-600a (85.1/11.5/3.4)
R-422B R-125/R-134a/R-600a (55/42/3)
R-422C R-125/R-134a/R-600a (82/15/3)
R-422D R-125/R-134a/R-600a (65.1/31.5/3.4)
R-423A R-134a/R-227ea (52.5/47.5)
R-424A R-125/R-134a/R-600a/R-600/R-601a (50.5/47/0.9/1/0.6)
R-425A R-32/R-134a/R-227ea (18.5/69.5/12)
R-426A R-125/R-134a/R-600/R-601a (5.1/93/1.3/0.6)
R-427A R-32/R-125/R-143a/R-134a (15/25/10/50)
R-428A R-125/R-143a/R-290/R-600a (77.5/20/0.6/1.9)

### R-500 R-12/R-152a (73.8/26.2)

### R-501 R-22/R-12 (75/25)

### R-502 R-22/R-115 (48.8/51.2)

### R-503 R-23/R-13 (40.1/59.9)

### R-504 R-32/R-115 (48.2/51.8)

### R-505 R-12/R-31 (78/22)

### R-506 R-31/R-114 (55.1/44.9)

### R-507 R-125/R-143a (50/50)

### R-508A R-23/R-116 (39/61)

### R-508B R-23/R-116 (46/54)

### R-509A R-22/R-218 (44/56)

The following clauses describe various embodiments.

1C. An apparatus comprising:

a tank comprising walls enclosing a space;
a gaseous material disposed in the space under pressure for storage; and
a phase change material configured to absorb heat from the gaseous material and change from a first state to a second state.

2C. An apparatus as in any of clauses 1C-11C wherein the phase change material is disposed in the space.

3C. An apparatus as in any of clauses 2C-11C wherein the phase change material is disposed within a hollow body in the space.

4C. An apparatus as in clause 3C wherein the hollow body includes a projection to create space between another hollow body for penetration by the gaseous material.

5C. An apparatus as in clause 3C wherein the hollow body is larger than an opening defined by a tank boss having a manifold attached.

6C. An apparatus as in any of clauses 1C-11C wherein the phase change material is disposed outside the tank in thermal communication with the tank.

7C. An apparatus as in any of clauses 1C-11C wherein the phase change material comprises a hydrocarbon having a chain length to determine a specific melting point within a range of conditions for a tank fill process.

8C. An apparatus as in any of clauses 1C-11C wherein the gaseous material comprises compressed natural gas (CNG), and the phase change material comprises a hydrocarbon having a boiling point within a range of conditions for a tank fill process.

9C. An apparatus as in clause 8C wherein the hydrocarbon comprises propane.

10C. An apparatus as in clause 8C wherein the hydrocarbon comprises butane.

11C. An apparatus as in any of clauses 1C-11C further comprising a fan disposed within the tank to promote heat exchange between the gaseous material and the phase change material.

12C. A method comprising:

flowing a gaseous material under pressure into a tank; and
causing a phase change material to absorb heat from the gaseous material and change from a first state to a second state.

13C. A method as in any of clauses 12C-20C further comprising disposing the phase change material inside the tank.

14C. A method as in any of clauses 13C-20C further comprising disposing the phase change material within a hollow body inside the tank.

15C. A method as in clause 13C further comprising removing the phase change material from the tank.

16C. A method as in clause 15C wherein the phase change material is removed prior to transporting the tank.

17C. A method as in clause 15C wherein the phase change material is removed with the gaseous material.

18C. A method as in clause 17C wherein the phase change material is compatible with an ultimate use of the gaseous material.

19C. A method as in clause 18C wherein the ultimate use comprises combustion.

20C. A method as in clause 17C wherein the phase change material is incompatible with an ultimate use of the gaseous material, the method further comprising separating the phase change material from the gaseous material prior to the ultimate use.

It is noted that conventional bulk gas transportation modules and/or trailers may be prone to failure during filling of the tanks. Examples of such failure modes can include but are not limited to the following.

1. The trailer may roll away if the brake is not engaged during filling.
2. The refueling receptacle may leak during filling if sand or dust gets in between the refueling nozzle and the fuel receptacle.
3. The refueling hose may fly off during filling, if the truck drives away or due to a quick disconnect failure.
4. A static charge may build up during filling due to the high flow of gas, generating an electric spark.
5. The connection between a trailer chassis and a tank module may be compromised (e.g., due to vandalism).
6. The pressure relief port of the tanks may be blocked due to water collecting in the vent stack and freezing.

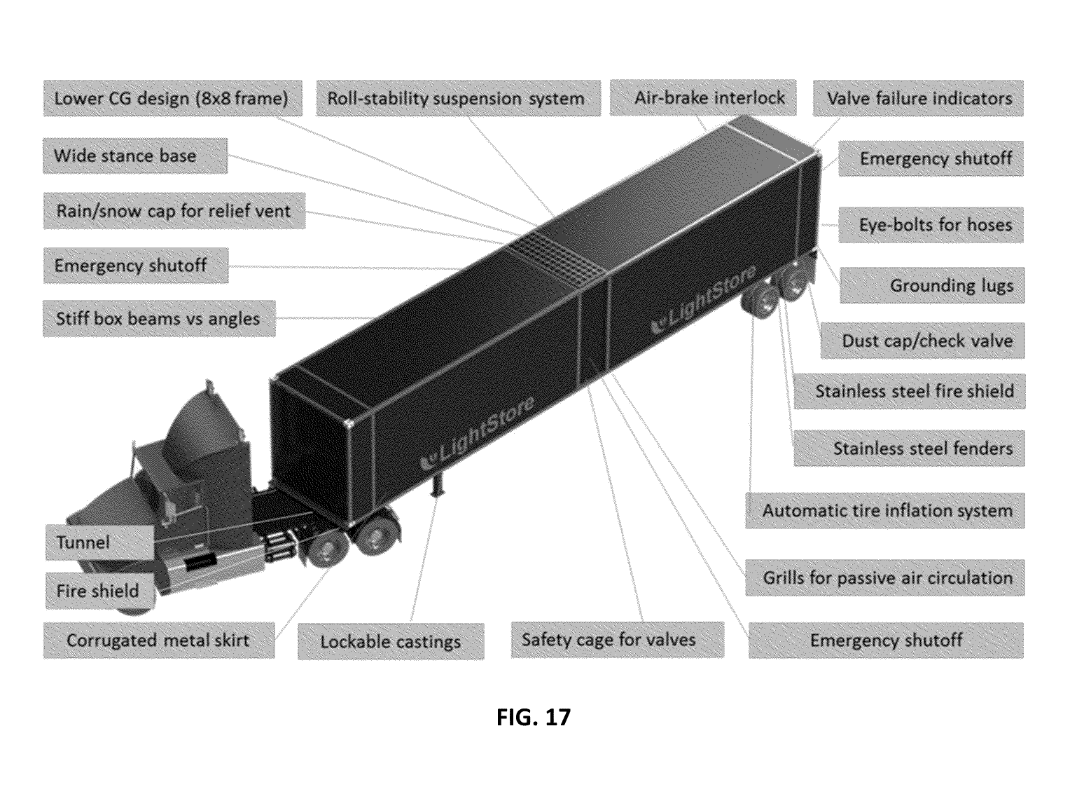

Embodiments may accordingly include one or more countermeasures to these failure modes. FIG. 17 is a simplified view of a tractor-trailer rig showing an overview of possible safety features, including one or more of the following.

1. An Air Brake interlock precludes movement when the access door to the receptacle is open.
2. A refueling receptacle is provided with a quick disconnect with built in check valves and dust cap to protect against contamination of receptacle.
3. An eyebolt connection to the module prevents whiplash. Hooks clamp onto a hose.
4. A grounding lug is on the frame, and a grounding feature is on the piping system.
5. A locking mechanism is provided on castings to discourage vandalism and/or accidental disengagement of the trailer and the module.
6. The vent stack corresponding to the pressure relief device is provided with a cap to prevent moisture ingress.

Moreover, when moving gases over the road, rail or water, conventional bulk gas transportation modules and trailers can fail. Examples of such failure modes can include but are not limited to the following.

1. The trailer may overturn or rollover, potentially damaging the tanks.
2. The tanks may be damaged by flying debris impacting them.
3. The trailer and/or module may catch fire, damaging the tanks and forcing them to release all gas to relieve pressure.

Accordingly, embodiments may incorporate measures appropriate to counter these failure modes. Examples can include the following.

1. Lower center of gravity design of the module and trailer, in combination with a wide stance on the trailer base, roll-stability support system and full enclosure of tanks within a frame.
2. The module is provided with a corrugated metal protection on bottom/sides/ends of the trailer to minimize damage from flying debris.
3. An automatic tire inflation system is provided on the trailer, since fires are often caused by underinflated tires; as semi-fluid grease is used since wheel bearing fires are common. The trailer wheels are protected by stainless steel fenders (aluminum or plastic can be a default material).

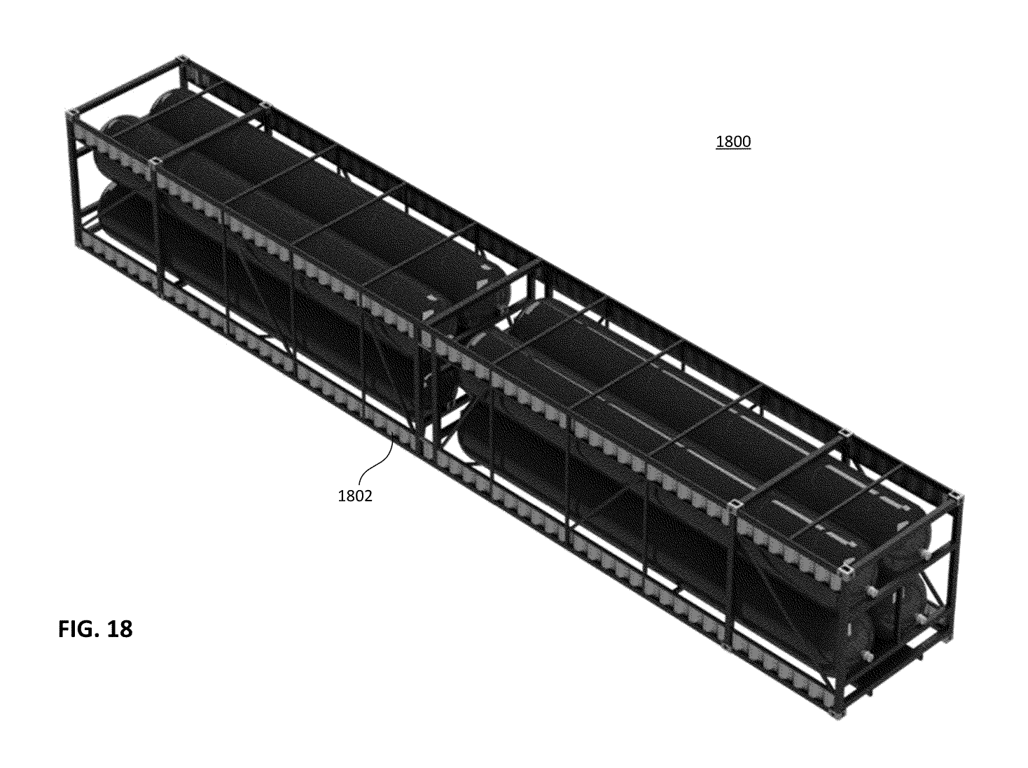

FIG. 18 is simplified cross-sectional view illustrating an embodiment of a transport module frame design 1800. Shown in this particular example, is a 53-foot module frame that maximizes storage capacity while remaining within regulatory weight limits.

A corrugated side curtain 1802 in conjunction with steel tubes increase the bending stiffness. In an example, the maximum deflection even when fully loaded and with g-force multipliers may not exceed 0.5 in. The tanks are fully enclosed in the frame such that the tanks are not damaged in case of a roll over accident.

A transport module according to embodiments may include one or more features in addition to those already described. For example, conventional storage tanks are periodically removed (e.g., every 3 or 5 years) from a transport module and subjected to visual inspection and hydro-statically proof-testing at specialized requalification centers. Unfortunately, this process is time consuming (e.g., on the order of weeks) and expensive (e.g., costing $60,000-100,000 each time).

However, the United States Department of Transportation (DOT) recently issued a permit approving the use of modal acoustic emission (MAE) testing of tanks in lieu of the conventional hydrostatic proof testing. This permit, issued Jul. 9, 2015 under DOT-SP 16190 to Digital Wave Corporation of Centennial, Colo. and incorporated by reference in its entirety herein for all purposes, approves such acoustic emission testing for composite pressure vessels with metallic liners.

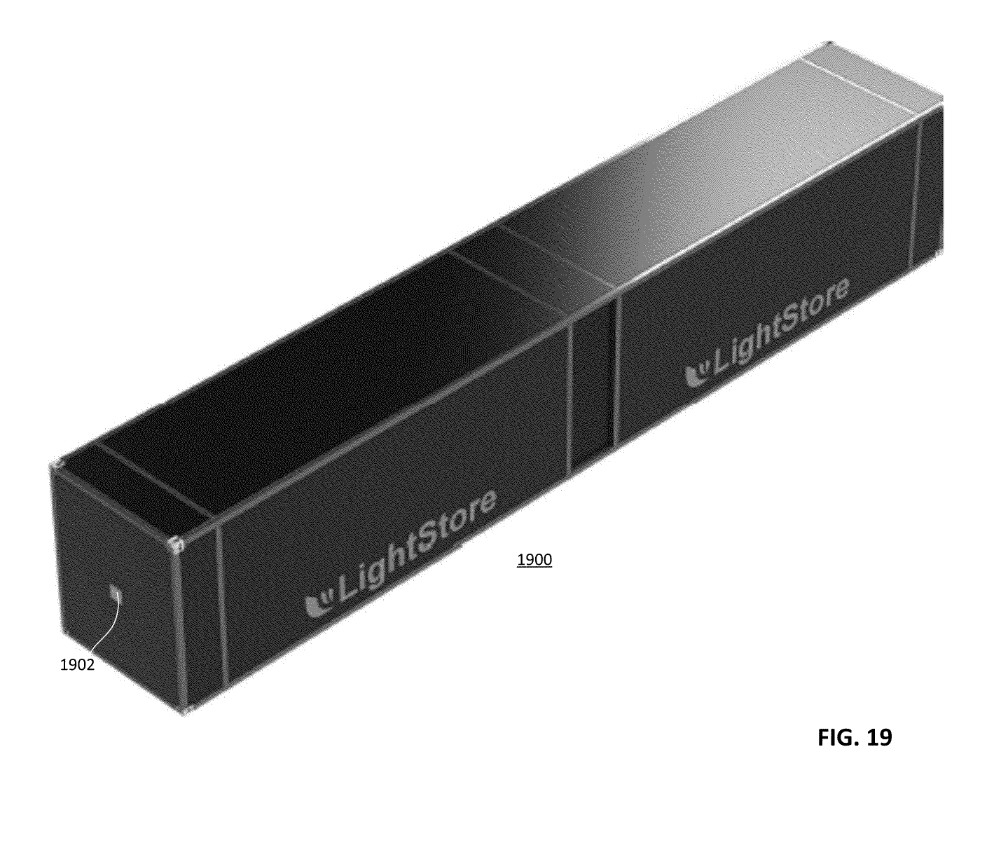

Thus, in various embodiments, a tank module may feature an access panel/port to afford periodic evaluation of the tanks using an in-situ acoustic emission testing method. FIG. 19 is simplified cross-sectional view illustrating a trailer 1900 according to such an embodiment, including an access port 1902 for acoustic emission testing.

This access panel allows acoustic emission testing of the tanks, while they remain within the module during a filling (pressurization) step. Specifically, the access panel permits a probe with acoustic emission sensors to be inserted into the module for taking readings from tanks while they are being pressurized.

### Example

### MAE Test System/Procedure

In an embodiment, the MAE testing system may include:

a. piezoelectric sensors;
b. pre-amplifiers;
c. high and low pass filters;
d. amplifiers;
e. analog-to-digital (A/D) converters;
f. a computer program for data collection;
g. a computer and monitor for data display;
h. a computer program for data analysis.

The MAE technician is able to examine the waveforms (event by event), and the waveforms for each event should correspond with the pressure and time data during the test. The MAE testing system includes sensors and recording equipment with a current (yearly) calibration sticker or certificate of calibration.

Pre-amplifiers and amplifiers may have a flat frequency response (±1 dB) over the sensor frequency range specified. The MAE system can include a high pass filter of 20 kHz, and a low pass filter with an appropriate roll-off frequency, such that digital aliasing of frequencies higher than the Nyquist frequency that are contained in the signal does not occur.

The MAE sensor specification, standard references and calibration may be as follows. The MAE sensors used may have a flat with frequency response measured in an absolute sense (±6 dB amplitude response from 50 kHz to 400 kHz), with a minimum sensitivity of 0.1 V/nm. Deviation from flat response (signal coloration) must be corrected using an absolute sensitivity curve obtained from an absolute surface wave calibration, similar to the calibration developed by the National Institute of Standards and Technology (NIST). MAE sensors can have a diameter not greater than 0.5 inches, and the aperture effect may be taken into account in the data analysis.

The MAE system can be calibrated to detect and measure the wave energy of the test object (e.g., fiber breakage from a composite cylinder) by using a rolling ball impactor and an inclined plate. The rolling ball impactor can be used to create an acoustical impulse in the aluminum-inclined-plate. The impact setup may include a steel ball ½ inch in diameter. The ball impactor may made of chrome steel alloy hardened to R/C 63, ground and lapped to a surface finish of 1.5 microinch, within 0.0001 of actual size and roundness within 0.000025 inch. The calibration Inclined Plate is made of aluminum alloy 7075-T6, and must be at least 4′×4′ in size, and 0.125 inch (0.003 meters) in thickness and be supported by steel blocks. The inclined plate includes a machined square groove ⅜″ wide which supports and guides the impact ball to the impact point. The length of groove and inclined angle may be 16″ and 6° respectively. The grooved inclined plate may be positioned next to the edge of the aluminum plate such that the equator of the ball impacts the mid-plane of the edge of the aluminum plate. The vertical position of the ball impact point may be gradually adjusted in order to “peak up” the acoustical signal, much as is done in ultrasonic testing where the angle is varied slightly to “peak up” the response.

A sample MAE test procedure is outlined as follows. After completion of MAE system calibration, two (2) sensors are mounted on each cylinder, one sensor installed at each end of a cylinder. The sensors are located within two inches of the dome-to-sidewall transition area and will be in-line along the axial direction of the vessel.

The system's settings can be as follows. The system's trigger threshold shall be at least 52 dBAE (adjusted to account for the sensor's absolute sensitivity response), with a sampling rate of 5 MHz and a memory depth of 2048 points.

Sensor coupling checks may be performed prior to each test to verify proper system operation, and sensor coupling to the vessel. For the coupling check, the E and F waveforms shall be observed by breaking pencil lead (Pentel 2H, 0.3 mm) at approximately 2 inches from each sensor along the axial direction of the vessel. The energy of the lead break wave forms shall be at least 5×10-15 Joules. If this energy level is not met, the sensor coupling shall be checked, or the sensor replaced. All calibration data is recorded.

An amplitude response performance check shall be carried out by a pencil lead break at a location centered along a line between the two sensors. Both sensors shall have a maximum amplitude response within 3 dB of each other. The gain settings for the calibration may be such that the signal does not saturate either the amplifiers of A/D converter. If so, the lead breaks are repeated at a system gain that does not saturate the system. Prior to pressurization, the gain may be reset to the test gain.

For the pressurization procedure according to this embodiment, each cylinder is pressurized from 0 psig to the cylinder's design test pressure (5/3 marked service pressure). During the pressurization, the cylinder is held at test pressure for at least 5 minutes and up to 15 minutes. If no MAE activity is recorded after a 5 minute interval during the test pressure hold, the cylinder is considered to be stable and the pressure may be reduced to 0 psig.

MAE waveforms are monitored and recorded during the pressurization procedure. Pressurization is stopped if background energy oscillations greater than a factor of 2 occur on either channel. The fill rate should be less than the rate at which flow noise first appears. A post-test system sensitivity check is conducted, and data saved. The test temperature may be between 50° F. (10° C.) and 120° F. (49° C.).

Acceptance/rejection criteria are now described. Prior to the evaluation of any acceptance/rejection criteria, any external noise such as electromagnetic interference (EMI), mechanical rubbing, flow noise, etc. should be filtered out.

Noise events are identified by their shape, spectral characteristics, or other information known about the test, such as a temporally associated disturbance due to the pressurization system or test fixture.

Rejection may be due to fiber break energy. Events occurring at the higher loads during pressurization having significant energy in the frequency range f>300 kHz may be due to fiber bundle, or partial fiber bundle breaks. These should not be present at normal operating pressure (working pressure) in a cylinder that has been tested to a much higher pressure and is now operated at working pressure. For fiber bundles to break while holding at operating pressure, the cylinder possesses a stress concentration. Such a cylinder may be removed from service.

In order to determine if fiber bundle breakage has occurred during the filling operation, the frequency spectra of the direct E and F waves shall be examined and the energies in certain frequency ranges.

Rejection may be due to Single Event Energy. The energy from the waveform of all events is measured from the recorded MAE data. A cylinder must be rejected if a measured MAE event energy is greater than 2.7×10⁻¹⁴ Joules for DOT-CFFC cylinders, and 1.5×10⁻¹³ Joules for DOT-FRP1 cylinders.

Rejection may be due to background energy. During pressurization, the background energy of any channel shall not rise above the quiescent background energy level by more than a factor of 2. Further, if an oscillation in the background energy greater than a factor of 2 (difference between adjacent maxima and minima values of an N point moving average of the background energy values) occurs at any time during the test, the vessel shall be depressurized immediately.

Any cylinder which violates the rise in the background energy level, or exhibits background energy oscillations greater than a factor of 2 shall be rejected.

Returning to FIG. 19, an access door/port in the trailer can serve functions other than/in addition to, facilitating acoustic emission testing. For example, each tank in a gas transportation module has a shut off valve. That valve must be in the closed position while a truck is on the road.

Usually, an operator needs to manually open valves to fill or discharge the tanks. This is time-consuming, since the valves generally cannot be accessed from the ground.

Accordingly, embodiments may provide a control box located at a readily accessible height, in order to remotely open and close all tank valves. Such a control box may also have indicators showing the valve position.

In certain embodiments, the control box may be located at the aft end (away from the tractor) of a gas transportation module, providing easy access by an operator for convenient ‘one touch’ gas filling/discharging operations while standing on the ground. Such positioning avoids the operator having to climb a ladder to open and close tank valves according to conventional practice.

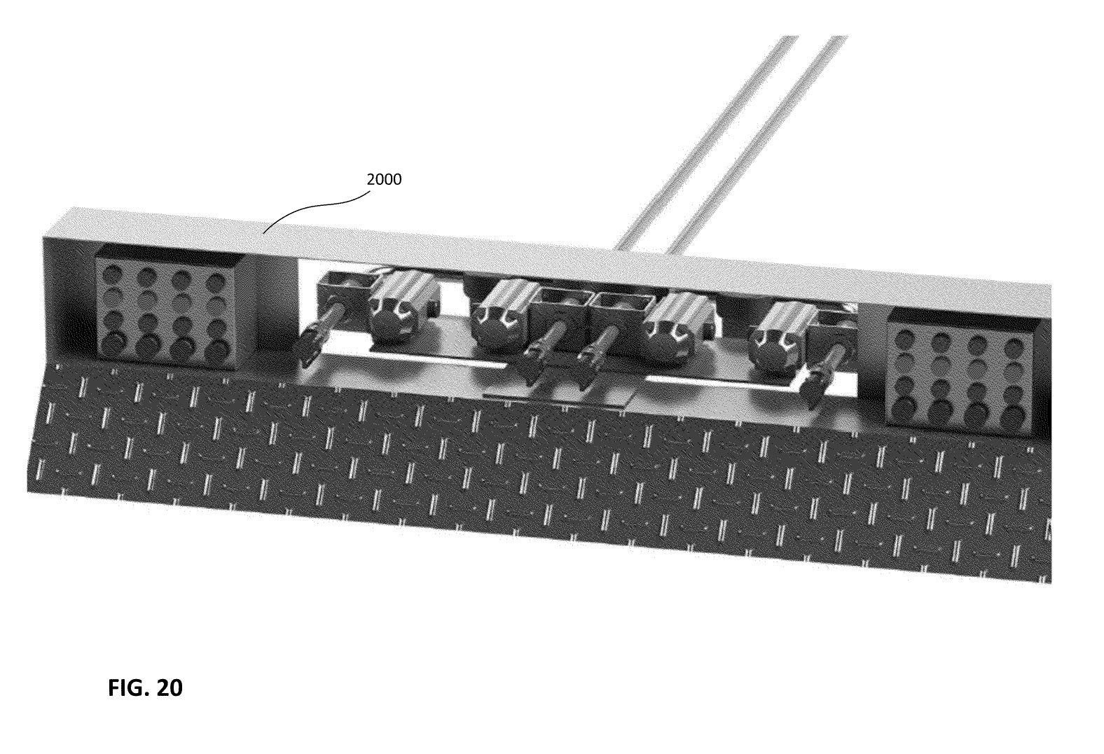

FIG. 20 accordingly depicts a perspective view of a control box 2000 according to an embodiment. The four nozzles shown are two fill receptacles and two discharge receptacles to fill and empty each of the two banks of 4-pack tanks. Different color indicators may be provided to show the status, e.g., filling (green), error (red), standby (blue), toggle switch (black).

The following clauses are directed to various embodiments.

1D. An apparatus comprising:

a container frame housed within a body;
a gas storage pressure vessel including a refueling receptacle and enclosed within the container frame; and
a port in the container frame permitting access to the refueling receptacle.

2D. An apparatus as in any of clauses 1D-9D wherein the body comprises a trailer, and the apparatus further comprises a brake interlock precluding movement of the trailer when the port is open.

3D. An apparatus as in any of clauses 2D-9D further comprising metal protection on bottom/sides/ends of the trailer.

4D. An apparatus as in any of clauses 2D-9D further comprising a locking mechanism on castings to prevent disengagement of the frame from the trailer.

5D. An apparatus as in any of clauses 2D-9D further comprising fenders and an automatic tire inflation system on the trailer.

6D. An apparatus as in clauses 1D-9D wherein the port is configured to permit an acoustic sensor to access the tank.

7D. An apparatus as in clauses 1D-9D wherein the refueling receptacle comprises a quick disconnect with built-in check valves and a dust cap.

8D. An apparatus as in clauses 1D-9D further comprising:

a piping system in communication with the refueling receptacle;
a grounding lug on the container frame; and
a grounding feature is on the piping system.

9D. An apparatus as in clauses 1D-9D further comprising a pressure relief device including a cap to prevent moisture ingress.

10D. An apparatus comprising:

a module comprising a plurality of compressed gas storage tanks within a frame enclosed by a trailer, each storage tank having a valve; and
a control box in communication with each of the valves to independently remotely open and close the valves, the control box located at a height affording access to a user standing on the ground.

11D. An apparatus as in clause 10D wherein the control box further comprises an indicator of valve position.

The above description illustrates various embodiments along with examples of how aspects of the present invention may be implemented. The above examples and embodiments should not be deemed to be the only embodiments, and are presented to illustrate the flexibility the inventive concept as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. An apparatus comprising:
a tank configured to contain a compressed gas and having a boss;
a temperature-sensing element proximate to the tank and configured to communicate a signal in response to a temperature change; and
a pressure relief device positioned at the boss and configured to be actuated in response to receipt of the signal.

2. An apparatus as in claim 1 further comprising a release device configured to receive the signal and actuate the pressure relief device.

3. An apparatus as in claim 1 wherein the pressure relief device comprises a pilot valve.

4. An apparatus as in claim 3 wherein the pilot valve is piloted by an internal pressure.

5. An apparatus as in claim 4 wherein the internal pressure comprises a tank pressure.

6. An apparatus as in claim 1 wherein the signal comprises a thermal signal.

7. An apparatus as in claim 6 wherein a material of the release device is configured to undergo a phase change in response to the signal.

8. An apparatus as in claim 7 wherein the material comprises a eutectic metal.

9. An apparatus as in claim 1 wherein the temperature-sensing element comprises a heat pipe.

10. An apparatus as in claim 1 wherein the signal comprises a pressure signal.

11. An apparatus as in claim 10 wherein the pressure signal comprises a pressure decrease.

12. An apparatus as in claim 11 wherein:
the temperature sensing element comprises a tube; and
the pressure decrease results from breaking a seal of the tube.

13. An apparatus as in claim 12 wherein the tube contains a fire suppression material.

14. An apparatus as in claim 10 wherein the pressure signal comprises a pressure increase.

15. An apparatus as in claim 10 further comprising a release device configured to actuate the pressure relief valve, the release device comprising a pneumatic valve.

16. An apparatus as in claim 1 wherein the signal comprises a mechanical force.

17. An apparatus as in claim 16 wherein the temperature sensitive element comprises a fusible link.

18. An apparatus as in claim 16 wherein the temperature sensitive element is bimetallic.

19. An apparatus as in claim 1 wherein the signal is electrical.

20. An apparatus as in claim 19 where the temperature sensitive element comprises a thermogenerator.

21. A method comprising:
a temperature sensitive element proximate to a tank containing compressed gas, communicating a thermal signal in response to a temperature change;
a release device receiving the thermal signal; and
in response to the thermal signal, the release device actuating a pressure relief device to vent compressed gas from the tank.

22. A method comprising:
a temperature sensitive element proximate to a tank containing compressed gas, communicating a pressure signal in response to a temperature change;
a release device receiving the pressure signal; and
in response to the pressure signal, the release device actuating a pressure relief device to vent compressed gas from the tank.
